(19) United States
(12) Patent Application Publication
(10) Pub. No.: US 2007/0244676 A1
(43) Pub. Date: Oct. 18, 2007

(54) Adaptive analysis methods

(76) Inventors: Li Shang, Kingston (CA); Yonghong Yang, Kingston (CA); Robert P. Dick, Evanston, IL (US)

Correspondence Address: Ralph A. Dowell of DOWELL & DOWELL P.C., 2111 Eisenhower Ave, Suite 406, Alexandria, VA, 22314, US

(21) Appl. No.: 11/713,790

(22) Filed: Mar. 5, 2007

Related U.S. Application Data
(60) Provisional application No. 60/778,365, filed on Mar. 3, 2006.

(51) Int. Cl. G06F 17/10

(52) U.S. Cl. 703/2; 703/13

(57) ABSTRACT

This invention relates to a comprehensive method of analyzing dynamic and steady-state properties of a system. Steady state (static), short time scale dynamic, and long time scale dynamic properties of the system are described by a plurality of elements. The method unifies spatial, temporal, and frequency-domain techniques to minimize analysis time while maintaining accuracy during both steady state, short time scale, and long time scale analysis. The method dynamically adapts spatial and temporal modeling granularity to achieve high efficiency while maintaining accuracy. The method is applicable to properties of a system that diffuse through space and/or time, such as temperature, concentration, density, etc., in fields such as biomedical modeling, molecular dynamics, meteorology, astrophysics, financial analysis, engineering, etc., and in particular, to thermal analysis of electronic devices such as integrated circuits.

### RELATED APPLICATIONS

This application claims the benefit of the filing date of U.S. Provisional Patent Application No. 60/778,365, filed on Mar. 3, 2006, the contents of which are incorporated herein by reference in their entirety.

### BACKGROUND OF THE INVENTION

With increasing integrated circuit (IC) power densities and performance requirements, thermal issues have become critical challenges in IC design [1]. If not properly addressed, increased IC temperature affects other design metrics including performance (via decreased transistor switching speed resulting from decreased charge carrier mobility and increased interconnect latency), power and energy consumption (via increased leakage power), reliability (via electromigration, thermal cycling, time-dependent dielectric breakdown, etc.), and price (via increased system cooling cost). It is thus critical to consider thermal issues during IC design and synthesis. When determining the impact of each decision in the synthesis or design process, the impacts of changed thermal profile on performance, power, price, and reliability must be considered. This requires repeated use of detailed chip-package thermal analysis. This analysis is generally based on computationally expensive numerical methods. In order to support IC synthesis, a thermal simulator must be capable of accurately analyzing models containing tens of thousands of discrete elements. Moreover, the solver must be fast enough to support numerous evaluations in the inner loop of a synthesis flow. Reliance on non-adaptive matrix operations that increase in space and time complexity superlinearly with matrix size (and model element count) has made achieving both accuracy and speed elusive.

The IC thermal analysis problem may be separated into two subproblems: steady-state (or static) analysis and dynamic analysis. Steady-state analysis determines the temperature profile to which an IC converges as time approaches infinity, given power and thermal conductivity profiles. Steady-state analysis is sufficient when an IC thermal profile converges before subsequent changes to its power profile and when transient thermal profiles, which might indicate short-term thermal peaks, may be neglected. Dynamic thermal analysis determines the temperature profile of an IC at any time given initial temperature, power, heat capacity, and thermal conductivity profiles. Although more computationally intensive than steady-state thermal analysis, dynamic thermal analysis is necessary when an IC power profile varies before its thermal profile has converged or when transient features of the thermal profile are significant.

Thermal analysis has a long history. Traditionally, thermal issues were solely addressed during cooling and packaging design based on worst-case analysis; in the past, thermal issues were typically ignored during IC design, or transferred as power constraints, e.g., a predefined peak power budget. A number of industrial tools were developed and widely used by packaging designers, such as FLOMERICS [2], ANSYS [3], and COMSOL (formerly known as FEMLAB) [4]. Since thermal analysis was conducted only a few times during the design process, efficiency was not a major concern. Typically, it took minutes or hours to conduct each simulation. Due to the increasing power density and cooling costs, such worst-case based cooling design has become increasingly difficult, if not infeasible. Researchers started addressing thermal issues during IC design, for which both the efficiency and accuracy of thermal analysis are critical. Recently, Skadron et al. developed a steady-state and dynamic thermal analysis tools, called HotSpot, for microarchitectural evaluation [5]. In HotSpot, matrix operations are based on LU decomposition. Therefore, only coarse-grained modeling is supported. In addition, neither the matrix techniques of the steady-state analysis tool nor the lock-step fourth-order Runge-Kutta time-marching technique used for dynamic analysis make use of spatial or asynchronous temporal adaptation; accuracy or performance suffer. Li et al. proposed a full-chip steady-state thermal analysis method [6]. In this work, matrix operations are handled using the multigrid method, which can efficiently support fine modeling granularity with a large number of grid elements. However, although the advantages of heterogeneous element discretization is noted, in this work, no systematic adaptation method is provided. Smy et al. proposed a quad-tree mesh refinement technique for thermal analysis [7] but did not consider local temporal adaptation. Zhan and Sapatnekar [8] proposed a steady-state thermal analysis method based on the Green's function formalism that was accelerated by using discrete cosine transforms and a look-up table. However, these methods [6,7,8] do not support dynamic thermal analysis. Liu et al. proposed a moment matching based thermal analysis method suitable for accelerating thermal analysis of course-grained architectural models [9]. Numerical analysis techniques were also proposed to characterize the thermal profile of on-chip interconnect layers [10,11,12]. Existing IC thermal analysis tools are capable of providing either accuracy or speed, but not both. Accurate thermal analysis requires expensive computation for many elements in some regions, at some times. Conventional IC thermal analysis techniques ensure accuracy by choosing uniformly fine levels of detail across time and space, i.e., they use equivalent physical sizes or time step durations for all thermal elements. The large number of elements and time steps resulting from such techniques makes them computationally intensive and, therefore, impractical for use within IC synthesis.

### SUMMARY OF THE INVENTION

According to a first aspect of the invention there is provided a method of analyzing a static property of a system, the property being described by a plurality of elements, the method comprising subjecting the elements to a recursive refinement multigrid relaxation method incorporating a hybrid tree structure.

According to a second aspect of the invention there is provided a method of analyzing a short time scale dynamic property of a system, the property being described by a plurality of elements, the method comprising dynamically adapting temporal and spatial partitioning resolution of the elements.

In one embodiment, dynamically adapting temporal and spatial partitioning resolution of the elements may comprise spatially and asynchronously temporally adaptive time marching.

According to a third aspect of the invention there is provided a method of analyzing a long time scale dynamic property of a system, the property being described by a plurality of elements, the method comprising dynamically adapting spatial partitioning resolution of the elements, and modifying frequency domain characteristics of the elements.

In one embodiment, modifying the frequency domain characteristics of the elements may comprise using a dynamic moment matching algorithm.

In various embodiments, combinations of static, short time scale, and long time scale properties may be analyzed using combinations of the methods described above.

A fourth aspect of the invention relates to a method of analyzing one or more properties of a system, the one or more properties being described by a plurality of elements, the method comprising at least one of: (a) subjecting the elements to a recursive refinement multigrid relaxation method incorporating a hybrid tree structure; (b) adapting temporal and spatial partitioning resolution of the elements; and (c) adapting spatial partitioning resolution of the elements and modifying frequency domain characteristics of the elements.

The property of the system may be a static property, and the method may comprise subjecting the elements to a recursive refinement multigrid relaxation method incorporating a hybrid tree structure.

The property of the system may be a short time scale property, and the method may comprise adapting temporal and spatial partitioning resolution of the elements. Adapting temporal and spatial partitioning resolution of the elements may comprise spatially and asynchronously temporally adaptive time marching.

The property of the system may be a long time scale property, and the method may comprise adapting spatial partitioning resolution of the elements and modifying frequency domain characteristics of the elements. Modifying the frequency domain characteristics of the elements may comprise using a moment matching algorithm.

The properties of the system may include static and short time scale properties, and the method may comprise: subjecting the elements to a recursive refinement multigrid relaxation method incorporating a hybrid tree structure; and adapting temporal and spatial partitioning resolution of the elements.

The properties of the system may include static, short time scale, and long time scale properties, and the method may comprise: subjecting the elements to a recursive refinement multigrid relaxation method incorporating a hybrid tree structure; and adapting spatial partitioning resolution of the elements and modifying frequency domain characteristics of the elements.

In one embodiment, the property is temperature.

In another embodiment, the system is an electronic device. The electronic device may be an integrated circuit. The system may be three-dimensional. The system may be a three-dimensional electronic device.

The method may be adapted for thermal analysis during one or more of design, simulation, synthesis, fabrication, and packaging of an electronic device.

A fifth aspect of the invention relates to a method of producing an electronic device, comprising conducting thermal analysis using a method as described herein on the device during design, simulation, synthesis, fabrication, and/or packaging of the device. The electronic device may be three-dimensional.

A sixth aspect of the invention relates to an electronic device produced in accordance with a method described herein.

A seventh aspect of the invention relates to a tool for thermal analysis during one or more of design, simulation, synthesis, fabrication, and packaging of an electronic device, comprising a method as described herein, embodied in a computer-readable medium. The electronic device may be three-dimensional.

### BRIEF DESCRIPTION OF THE DRAWINGS

Embodiments of the invention will now be described, by way of example, with reference to the accompanying drawings, wherein:

FIG. 1 is a block diagram showing thermal-aware synthesis flow;

FIG. 2 is schematic diagram of a silicon chip and package;

FIG. 3 is a graphical representation of a temperature profile for an active layer and heatsink;

FIG. 4 is a plot showing inter-element thermal gradient distribution;

FIG. 5 is a plot showing normalized maximum step size distribution;

FIG. 6 is a block diagram showing an overview of ISAC (incremental self-adaptive chip-package thermal analysis) according to one embodiment of the invention;

FIG. 7 is a diagrammatic representation of heterogeneous spatial resolution adaptation;

FIG. 8 is plot showing an example of estimating error as a function of step size for a first-order method;

FIG. 9 a plot showing the need for element local time deviation bound;

FIG. 10 shows plots of (a) normalized inter-element temperature differences and (b) normalized maximum step size;

FIG. 11 is a graphical representation of spatial discretization refinement;

FIG. 12 shows plots of (a) contribution to system response coefficients by thermal element and moment for single output port and (b) contribution to system response coefficients by thermal element and moment for separate output ports;

FIG. 13 is a plot showing accuracy of the moment matching method of an embodiment of the invention;

FIG. 14 is a block diagram showing thermal-aware power estimation flow according to an embodiment of the invention;

FIG. 15 is plot showing normalized leakages for HSPICE, piece-wise linear, and linear models using the 65 nm process for c7552 and SRAM;

FIG. 16 is a plot showing Linear leakage model errors for c7552 and SRAM;

FIG. 17 is an embodiment of a steady-state power distribution model;

FIG. 18 is a plot showing leakage estimation error of FPGA under a worst-case power profile; and

FIG. 19 is a plot showing thermal error breakdown among different types of ICs.

### DETAILED DESCRIPTION OF PREFERRED EMBODIMENTS

### 1. Overview

The invention relates to a method of speeding up numerical analysis of systems involving large numbers (e.g., thousands, hundreds of thousands) of discrete elements that relate to static and dynamic properties of a two- or three-dimensional (2-D or 3-D) system that diffuse through space and/or time. Such properties of systems may be, for example, temperature, light, density, charge, concentration, humidity, pressure, entropy, etc. Such systems may relate to fields such as, but not limited to, biomedical, molecular dynamics (e.g., protein folding), meteorology, astrophysics, engineering failure analysis, financial analysis, and electronics. For the purpose of this disclosure, the invention is applied to the field of electronics and the thermal analysis of electronic systems. Electronic systems to which the method may be applied include electronic devices such as integrated circuits (ICs) and any form of hybrid circuit such as printed circuit boards, circuits employing thin film or thick film components, and circuits fabricated on any type of semiconductor or non-conducting substrate such as ceramic or glass, any of which may be 2-D or 3-D. The method is applicable to one or more of the design, simulation, synthesis, fabrication, and packaging of electronic devices, insofar as one or more such steps may be combined during production of an electronic device, depending on factors such as the complexity of the device. The invention may be combined with other analytical procedures, either simultaneously or sequentially, such as those associated with electric, logic, etc. parameters of the device, so as to efficiently optimize multiple characteristics of the device.

As used herein with respect to an electronic device such as, for example, an integrated circuit, the term “three-dimensional” is intended to refer to an electronic device having stacked functional layers, each such layer including one or more passive component (e.g., resistor, capacitor, inductor) and/or one or more active component (e.g., transistor, rectifier). An electronic device not having such stacked functional layers is referred to herein as “two-dimensional”.

As applied to thermal analysis of IC design, the invention provides validated, synthesis-oriented IC thermal analysis techniques that differ from existing work by doing operation-by-operation dynamic adaptation of temporal and spatial resolution in order to dramatically reduce computational overhead without sacrificing accuracy. Experimental results indicate that the spatial adaptation technique described herein improves CPU time by at least 690×, and that the temporal adaptation technique improves CPU time by over 300×. Although much faster than conventional analysis techniques, the techniques described herein have been designed for accuracy even when this increases complexity and run time, e.g., by correctly modeling the dependence of thermal conductivity on temperature. These algorithms have been validated against COMSOL Multiphysics [4], a reliable commercial finite element physical process modeling package, and a high-resolution numerical spatially and temporally homogeneous simultaneous differential equation solver. Experimental results indicate that using existing thermal analysis techniques within the IC synthesis flow would increase CPU time by many orders of magnitude, making it impractical to synthesize complex ICs.

### 2. Motivating Examples

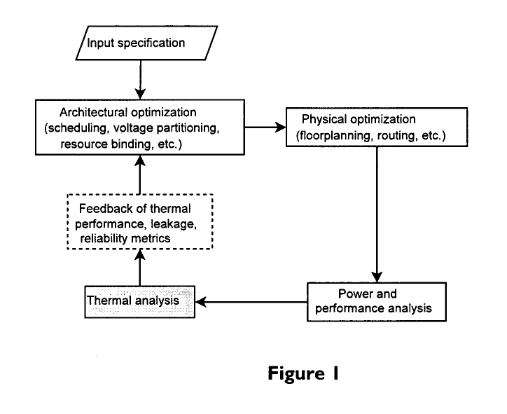

In this section, we use a thermal-aware IC synthesis flow to demonstrate the challenges of fast and accurate IC thermal analysis. FIG. 1 shows an integrated behavioral-level and physical-level IC synthesis system [14]. This synthesis system uses a simulated annealing algorithm to jointly optimize several design metrics, including performance, area, power consumption, and peak IC temperature. It conducts both behavioral-level and physical-level stochastic optimization moves, including scheduling, voltage assignment, resource binding, floorplanning, etc. An intermediate solution is generated after each optimization move. A detailed two-dimensional active layer power profile is then reported based on the physical floorplan. Thermal analysis algorithms are invoked to guide optimization moves.

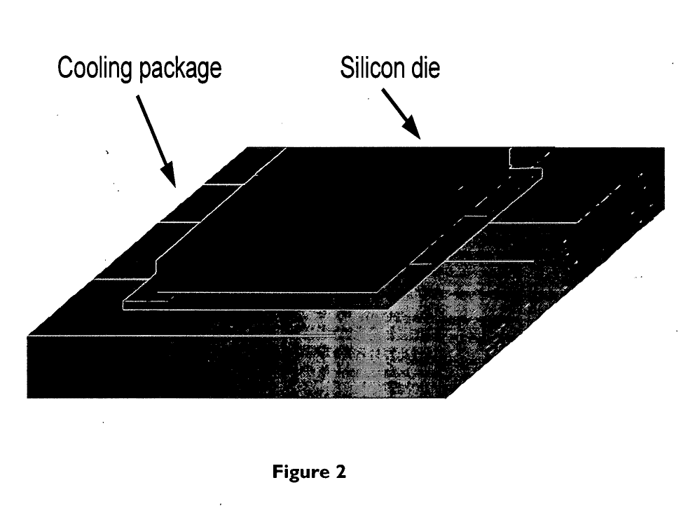

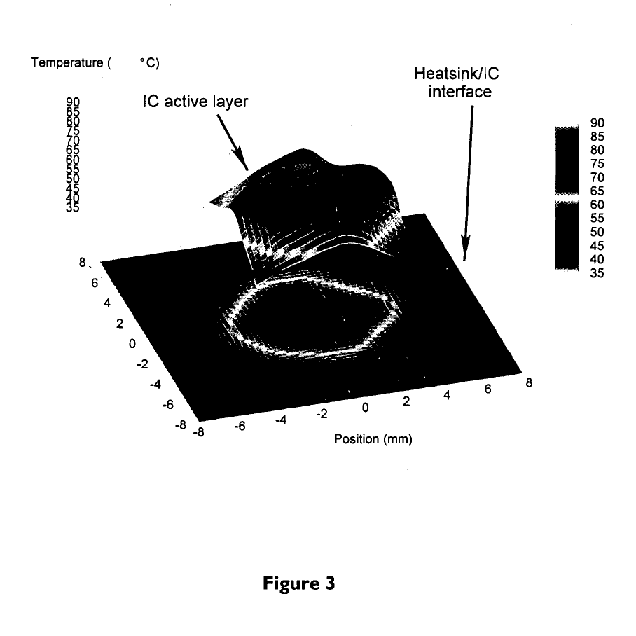

As illustrated by the example synthesis flow, for each intermediate solution, detailed thermal characterization requires full chip-package thermal modeling and analysis using computationally-intensive numerical methods. FIGS. 2 and 3 show a full chip-package thermal modeling example from an IBM IC design (see Section 4.1 for more detail). The steady-state thermal profile of the active layer of the silicon die in conjunction with the top layer of the cooling package, shown in FIG. 3, were characterized using a multigrid thermal solver by partitioning the chip and the cooling package into 131,072 homogeneous thermal elements. Without spatial and temporal adaptation, the solver requires many seconds or minutes when run on a high-performance workstation. Compared to steady-state thermal modeling, characterizing IC dynamic thermal profile is even more time consuming. IC synthesis requires a large number of optimization steps; thermal modeling can easily become its performance bottleneck.

A key challenge in thermal-aware IC synthesis is the development of fast and accurate thermal analysis techniques. Fundamentally, IC thermal modeling is the simulation of heat transfer from thermally dissipative elements (e.g., transistors and interconnections), through silicon die and cooling package, to the ambient environment. This process is modeled with partial differential equations. In order to approximate the solutions of these equations using numerical methods, finite discretization is used, i.e., an IC model is decomposed into numerous three-dimensional elements. Adjacent elements interact via heat diffusion. Each element is sufficiently small to permit its temperature to be expressed as a difference equation that is a function of time, its material characteristics, its power dissipation, and the temperatures of its neighboring elements.

In an approach analogous to electric circuit analysis, thermal RC (or R) networks are constructed to perform dynamic (or steady-state) thermal analysis. Direct matrix operations, e.g., inversion, may be used for steady-state thermal analysis. However, the computational demand of this technique hinders its use within synthesis. Dynamic thermal analysis may be conducted by partitioning the simulation period into small time steps. The local times of all elements are then advanced, in lock-step, using transient temperature approximations yielded by difference equations. The computational complexity of dynamic thermal analysis is a function of the number of grid elements and time steps. Therefore, to improve the efficiency of thermal modeling, the key issue is to optimize the spatial and temporal modeling granularity, eliminating non-essential elements and stages.

There is a tension between accuracy and efficiency when choosing modeling granularity. Increasing modeling granularity reduces analysis complexity but may also decrease accuracy. Uniform temperature is assumed within each thermal element; intra-element thermal gradients are neglected. Therefore, increasing spatial modeling granularity naturally increases modeling errors. Similarly, increasing time step duration may result in failure to capture transient thermal fluctuation or may increase truncation error when the actual temperature functions of some elements are of higher order than the difference equations used to approximate them.

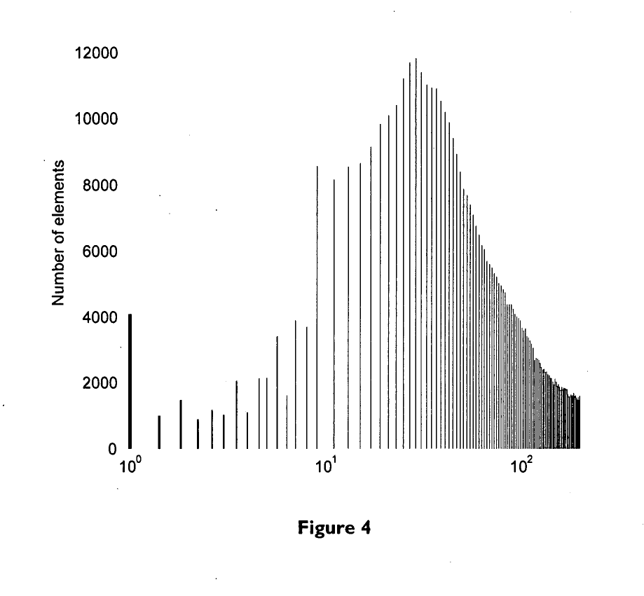

IC thermal profiles contain significant spatial and temporal variation due to the heterogeneity of thermal conductivity and heat capacity in different materials, as well as varying power profiles resulting from non-uniform functional unit activities, placements, and schedules. FIG. 4 shows the inter-element thermal gradient distribution using homogeneous meshing of the example shown in FIG. 3. This histogram is normalized to the smallest inter-element thermal gradient. This figure contains a wide distribution of thermal gradients: heterogeneous spatial element discretization refinement based on thermal gradients has the potential to improve performance without impacting accuracy.

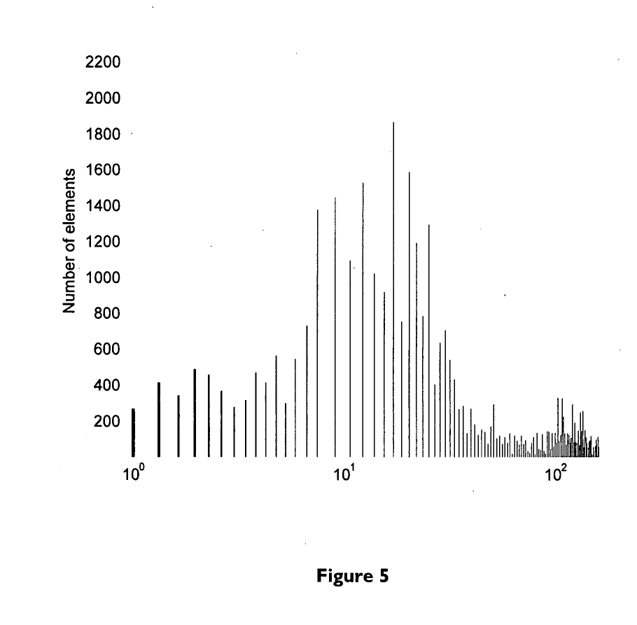

For dynamic thermal simulation, the size of each thermal element's time steps should permit accurate approximation by the element difference equations. An IC may experience different thermal fluctuations at different locations. Therefore, the best time step durations for elements at different locations may vary. FIG. 5 shows the maximum potential time step duration of each individual block based on local thermal variation; local adaptation of time step sizes has the potential to improve performance without degrading accuracy.

### 3. Thermal Analysis Model and Algorithms

This section gives details on the invention as embodied in a software package, namely, ISAC (incremental self-adaptive chip-package thermal analysis). Section 3.1 defines the steady-state and dynamic IC thermal analysis problems. Section 3.2 gives an overview of the algorithms used by ISAC. Section 3.3 gives an overview of multigrid analysis and describes the spatial adaptation techniques used by ISAC to accelerate analysis. Section 3.4 gives an overview of time-marching and describes the temporal adaptation techniques used by ISAC. Section 3.5 points out the accuracy benefits of considering the dependence of thermal conductivity upon temperature within a thermal model. Section 3.6 explains the interface between ISAC and an IC synthesis algorithm.

3.1. IC Thermal Analysis Problem Definition

IC thermal analysis is the simulation of heat transfer through heterogeneous material among heat producers (e.g., transistors) and heat consumers (e.g., heat sinks attached to IC packages). Modeling thermal conduction is analogous to modeling electrical conduction, with thermal conductivity corresponding to electrical conductivity, power dissipation corresponding to electrical current, heat capacity corresponding to electrical capacitance, and temperature corresponding to voltage.

The equation governing heat diffusion via thermal conduction in an IC follows.

$$ρ c \frac{\partial T ( \vec{r} , t )}{\partial t} = ∇ ( k ( \vec{r} ) ∇ T ( \vec{r} , t ) ) + p ( \vec{r} , t ) \qquad ( 1 )$$

subject to the boundary condition

$$k ( \vec{r} , t ) \frac{\partial T ( \vec{r} , t )}{\partial {n}_{i}} + {h}_{i} T ( \vec{r} , t ) = {f}_{i} ( \vec{r} , t ) \qquad ( 2 )$$

In Equation 1, ρ is the material density; c is the mass heat capacity; T(\vec{r},t) and k(\vec{r}) are the temperature and thermal conductivity of the material at position \vec{r} and time t; and p(\vec{r},t) is the power density of the heat source. In Equation 2, nᵢ is the outward direction normal to the boundary surface i, hᵢ is the heat transfer coefficient; and ƒᵢ is an arbitrary function at the surface i. Note that, in reality, the thermal conductivity, k, also depends on temperature (see Section 3.5). ISAC supports arbitrary heterogeneous three-dimensional thermal conduction models. For example, a model may be composed of a heat sink in a forced-air ambient environment, heat spreader, bulk silicon, active layer, and packaging material or any other geometry and combination of materials.

In order to do numerical thermal analysis, a seven point finite difference discretization method can be applied to the left and right side of Equation 1, i.e., the IC thermal behavior may be modeled by decomposing it into numerous rectangular parallelepipeds, which may be of non-uniform sizes and shapes. Adjacent elements interact via heat diffusion. Each element has a power dissipation, temperature, thermal capacitance, as well as a thermal resistance to adjacent elements. The discretized equation at an interior point of a grid element follows.

$$\begin{matrix}ρ cV \frac{{T}_{i , j , l}^{m + 1} - {T}_{i , j , l}^{m}}{Δ t} = - 2 ( {G}_{x} + {G}_{y} + {G}_{z} ) {T}_{i , j , l}^{m} + {G}_{x} {T}_{i - 1 , j , l}^{m} + \\ {G}_{x} {T}_{i + 1 , j , l}^{m} + {G}_{y} {T}_{i , j - 1 , l}^{m} + {G}_{y} {T}_{i , j + 1 , l}^{m} + \\ {G}_{z} {T}_{i , j , l - 1}^{m} + {G}_{z} {T}_{i , j , l + 1}^{m} + {Vp}_{i , j , l}\end{matrix} \qquad ( 3 )$$

where i, j, and l are discrete offsets along the x, y, and z axes. Given that Δx, Δy, and Δz are discretization steps along the x, y, and z axes, V=ΔxΔyΔz. Gₓ, G_{y} and G_{z} are the thermal conductivities between adjacent elements. They are defined as follows: Gₓ=kΔyΔz/Δx, G_{y}=kΔxΔz/Δy, and G_{z}=kΔxΔy/Δz. Δt is the discretization step in time t.

For an IC chip-package design with N discretized elements, the thermal analysis problem can be described as follows.
CT(t)′+AT(t)=Pu(t) (4)
where the thermal capacitance matrix, C, is an [N×N] diagonal matrix; the thermal conductivity matrix, A, is an [N×N] sparse matrix; T(t) and P(t) are [N×1] temperature and power vectors; and u(t) is the time step function. For steady-state analysis, the left term in Equation 4 expressing temperature variation as function of time, t, is dropped. For either the dynamic or steady-state version of the problem, although direct solutions are theoretically possible, the computational expense is too high for use on high-resolution thermal models.
3.2. ISAC Overview

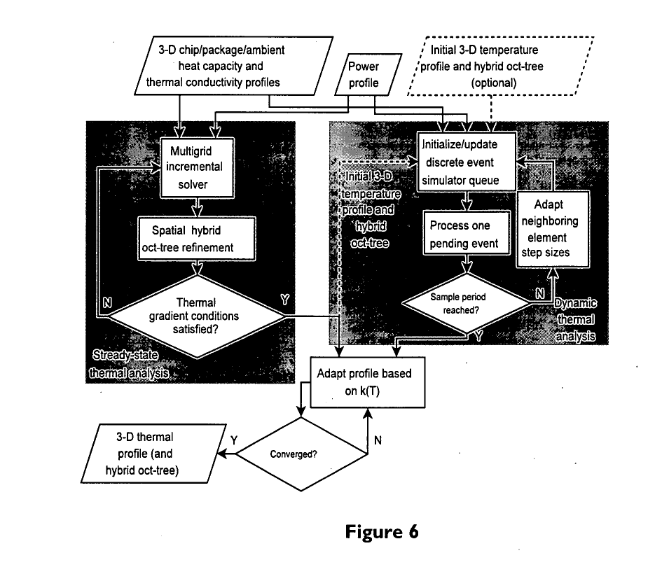

FIG. 6 gives an overview of ISAC, our proposed incremental, space and time adaptive, chip-package thermal analysis tool. When used for steady-state thermal analysis, it takes, as input, a three-dimensional chip and package thermal conductivity profile, as well as a power dissipation profile. A multigrid incremental solver is used to progressively refine thermal element discretization to rapidly produce a temperature profile.

When used for dynamic thermal analysis, in addition to the input data required for steady-state analysis, ISAC requires the chip-package heat capacity profile. In addition, it may accept an initial temperature profile and an efficient thermal element discretization. If these inputs are not provided, the dynamic analysis technique uses steady-state analysis to produce its initial temperature profile and element discretization. It then repeatedly updates the local temperatures and times of elements at asynchronous time steps, appropriately adapting the step sizes of neighbors to maintain accuracy.

As described in Section 3.5, after analysis is finished, the temperature profile may be adapted using a feedback loop in which thermal conductivity is modified based upon temperature in order to account for non-linearities induced by the dependence of the thermal conductivity or leakage power consumption on temperature. Upon convergence, the temperature profile is reported to the IC synthesis tool or designer.

3.3. Spatial Adaptation in Thermal Analysis

During thermal analysis, both time complexity and memory usage are linearly or superlinearly related to the number of thermal elements. Therefore, it is critical to limit the discretization granularity. As shown in FIG. 4, IC thermal profiles may contain significant spatial variation due to the heterogeneity of thermal conductivity and heat capacity in different materials, as well as the variation of power profile.

In this section, we present an efficient technique for adapting thermal element spatial resolution during thermal analysis. This technique uses incremental refinement to generate a tree of heterogeneous rectangular parallelepipeds that supports fast thermal analysis without loss of accuracy. Within ISAC, this technique is incorporated with an efficient multigrid numerical analysis method, yielding a comprehensive steady-state thermal analysis solution. Dynamic thermal analysis also benefits from the proposed spatial adaptation technique due to the dramatic reduction of the number of grid elements that must be considered during time-marching simulation.

3.3.1. Hybrid Data Structure

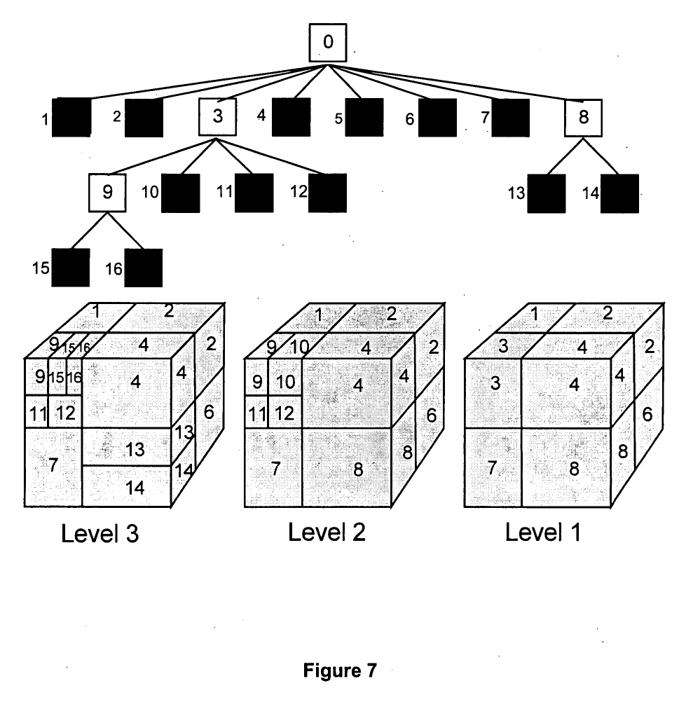

Efficient spatial adaptation in thermal analysis relies on sophisticated data structures, i.e., it requires the efficient organization of large data sets and representation of multi-level modeling resolutions. In addition, efficient algorithms for inter-level transition are necessary for adaptive thermal modeling and numerical analysis. In ISAC, the proposed spatial adaption technique is supported by a hybrid oct-tree data structure, which provides an efficient and flexible representation to enable spatial resolution adaptation. A hybrid oct-tree is a tree that maintains spatial relationships among rectangular parallelepipeds in three dimensions. In a hybrid oct-tree, each node may have two, four, or eight immediate children. FIG. 7 shows an example of hybrid oct-tree representation. As shown in this figure, in the hybrid oct-tree, different modeling resolutions are organized into contours along the tree hierarchy. In this example, nodes (elements) 1, . . . ,8 form a level 1 contour; nodes (elements) 1,2,4, . . . ,7,9, . . . ,14 form a level 2 contour; leaf nodes (elements), shown as shaded blocks, 1,2,4, . . . ,7,10, . . . ,16 form a level 3 contour. Heterogeneous spatial resolution may result in a thermal element residing at multiple resolution levels, e.g., element 2 resides at level 1, 2, and 3. This information is represented as nodes existing in multi-level contours in the tree.

Spatial resolution adaption requires two basic operations, partitioning and coarsening. In a hybrid oct-tree, partitioning is the process of breaking a leaf node along arbitrary orthogonal axes, e.g., nodes 13 and 14 result from partitioning node 8. Coarsening is the process of merging direct sub-nodes into their parent, e.g., node 9, . . . ,12 merged into node 3.

To conduct thermal analysis across different discretization resolutions, we propose an efficient contour search algorithm with computational complexity N, that determines thermal grid elements belonging to a particular discretization resolution level. As shown in Algorithm 1, leaf nodes are assigned to the finest resolution level (lines 1-3). The resolution level of a parent node of a subtree equals the minimal resolution level of all of its intermediate children nodes, levelₘᵢₙ, minus one (lines 4-7 and 13). An element may reside in multiple resolution levels (lines 8-12). More specifically, in each subtree, each intermediate child node, chi_nodeᵢ, belongs to contours from levelₘᵢₙ to level_{chi}_{_{—}}_{node}_{ᵢ}. Algorithm 1 provides an efficient solution to traverse different spatial resolutions, thereby supporting fast multigrid thermal analysis.

Algorithm 1. hybrid tree traversal(nodeᵣₒₒₜ)

| | |
|---|---|
| 1: | if nodeᵣₒₒₜ is a leaf node then |

| | |
|---|---|
| 2: | Add nodeᵣₒₒₜ to contour_{finest}_{_{—}}level |
| 3: | Return finest_level |

| | |
|---|---|
| 4: | end if |
| 5: | for each intermediate child chi_nodeᵢ do |

| | |
|---|---|
| 6: | level_{chi}_{_{—}}node_{ᵢ} = hybrid_tree_traversal(chi_nodeᵢ) |
| 7: | levelₘᵢₙ = min(levelₘᵢₙ, level_{chi}_{_{—}}node_{ᵢ}) |

| | |
|---|---|
| 8: | end for |
| 9: | ffor each intermediate child chi_nodeᵢ do |

| | |
|---|---|
| 10: | if level_{chi}_{_{—}}node_{ᵢ} > levelₘᵢₙ then |
| 11: | Add chi_nodeᵢ to contourₗₑᵥₑₗ_{_{chi+113 node i−1}}, . . ., contourₗₑᵥₑₗₘᵢₙ |
| 12: | end if |

| | |
|---|---|
| 13: | end for |
| 14: | Add nodeᵣₒₒₜ to contourₗₑᵥₑₗ_{ₘᵢₙ}−1 |
| 15: | Return levelₘᵢₙ − 1 |

3.3.2. Multigrid Method

For steady-state thermal analysis, the heat diffusion problem is (approximately) described by the following linear equation, AT=P. The size of the thermal conductivity matrix, A, increases quadratically with the number of discretization grid elements. Therefore, directly solving this equation is intractable. Iterative numerical methods are thus widely used. The quality of iterative methods is typically characterized by their convergence rates. Convergence rate is a function of the error field frequency [15]. Standard iterative methods, such as those of Jacobi and Gauss-Siedel have slow convergence rates due to inefficiency in removing low frequency errors. This problem becomes more prominent under fine-grain discretization.

In this work, we developed a multigrid iterative relaxation solver for steady-state thermal analysis. Multigrid methods are among the most efficient techniques for solving large scale linear algebraic problems arising from the discretization of partial differential equations [15,16]. In conjunction with linear solvers, the multigrid method provides an efficient multi-level relaxation scheme. Using this technique, low frequency errors, which limit the performance of standard iterative methods, are transferred into the high frequency domain through grid coarsening. Algorithm 2 shows the proposed multigrid method. This method consists of a set of relaxation stages across the discretization hierarchy, where each stage is responsible for eliminating a particular frequency bandwidth of errors. Given a thermal conductivity matrix A and power profile P, a multigrid cycle starts from the finest granularity level (line 1), at which iterative relaxation is conducted using a linear solver to remove high frequency errors until low frequency errors dominate. Next, using interpolation, the solution at the finest granularity level is transformed to a coarser level, in which the original low frequency errors from the finest granularity level manifest themselves as high frequency errors. This restriction procedure is applied recursively (line 9) until the coarsest level is reached (line 6). Then, a reverse procedure, called prolongation, is used to interpolate coarser corrections back to a finer level recursively across the grid discretization hierarchy (line 11). The final result is the estimated steady-state IC chip-package thermal profile.

Algorithm 2. Multigrid cycle

Require: Thermal conductivity matrix A , power profile vector P AT = P
Ensure: AT = P
1: Pre-smoothing step: Iteratively relax initial random solution.
{HF error eliminated.}
2: subtask Coarse grid correction
3: Compute residue from finer grid.
4: Approximate residue in coarser grid.
5: Solve coarser grid problem using relaxation.
6: if coarsest level has been reached then
7: Directly solve problem at this level.
8: else
9: Recursively apply the multigrid method.
10: end if
11: Map the correction back from the coarser to finer grid.
12: end subtask
13: Post smoothing step: Add correction to solution at finest grid level.
14: Iteratively relax to obtain the final solution.

3.3.3. Incremental Analysis

In this work, the spatial discretization process is governed by temperature difference constraints. Iterative refinement is conducted in a hierarchical fashion. Upon initialization, the steady-state thermal analysis tool generates a coarse homogeneous oct-tree based on the chip size. Iterative temperature approximation is repeated until convergence to a stable profile. Elements across which temperature varies by more than thermal difference constraints are further partitioned into sub-elements. Given that Tᵢ is the temperature of element i and that S is the temperature threshold, for each ordered element pair, (i,j), the new number of elements, Q, along some partition g follows.

$$Q = ⌈ {log}_{2} \frac{{T}_{i} - {T}_{j}}{S} ⌉ \qquad ( 5 )$$

For each element, i, partitions along three dimensions are gathered into a three-tuple (xᵢ,yᵢ,zᵢ) that governs partitioning element i into a hybrid sub oct-tree. The number of sub-elements depends on the ratio of the temperature difference to the threshold. Therefore, some elements may be further partitioned and local thermal simulation repeated. Simulation terminates when all element-to-element temperature differences are smaller than the predefined threshold, S. This method focuses computation on the most critical regions, increasing analysis speed while preserving accuracy.
3.4. Temporal Adaptation in Thermal Analysis

ISAC uses an adaptive time-marching technique for dynamic thermal analysis. A number of authors have written wonderful introductions to time-marching methods [17,18]. Time-marching is a numerical method to solve simultaneous partial differential equations by iteratively advancing the local times of elements. The proposed technique is loosely related to the adaptive Runge-Kutta method [17] described in Section 2. The computational cost of a finite difference time-marching technique is approximately Σ_{e∈E}uₑcₑ where E is the set of all elements, uₑ is the number of time steps for a given element, and cₑ is the time cost per evaluation for that element. For Runge-Kutta methods, assuming a constant evaluation time and noting that all elements experience the same number of updates, run time can be expressed as ucΣ_{e∈E}nₑ where n is the number of a block's transitive neighbors. For these methods, element time synchronization eliminates the need to repeatedly evaluate transitive neighbors, yielding a time cost of |E|uc.

Analysis time is classically reduced by attacking u, the number of time steps, either by using higher-order methods that allow larger time steps under bounded error or by adapting global step size during analysis, e.g., the adaptive Runge-Kutta methods. Higher-order methods allows the actual temperature function to be accurately approximated for a longer span of time, reducing the number of steps necessary to reach the target time.

3.4.1. Two Popular Time-Marching Techniques

For conventional synchronous methods, it is necessary to select a fixed time step size that is small enough to satisfy an error bound, i.e.,

$${h}^{f} = {min}_{t ∈ Ue ∈ E} {S}_{te} \qquad ( 6 )$$

where h^{f} is the fixed step size to use throughout analysis, t is the time from U, the set of all explicitly visited times within the sample period, e is an element from E, the set of all elements, and Sₜₑ is the maximum safe step size for element e at time t. Although the weaker assurance of accuracy at the sample period would be sufficient, in practice this requires that accuracy be maintained throughout time-marching due to the dependence of element temperatures on their predecessors. Non-adaptive time-marching is used in existing popular dynamic thermal analysis packages, e.g., HotSpot [5].

Further improvement is possible via the use of a synchronous adaptive time-marching method. In such methods, the time step is adjusted such that the largest globally safe step is taken, i.e.,

$${∀}_{t ∈ U} {h}_{t}^{s} = {min}_{e ∈ E} {S}_{te} \qquad ( 7 )$$

where hₜ^{s} is the step size to be used at time t.
3.4.2. Asynchronous Element Time-Marching

Although synchronous adaptive time-marching has the potential to outperform non-adaptive techniques, much greater gains are possible. As noted in Section 2, the requirement that all thermal elements be synchronized in time implies that, at each time step, all elements must have their local times advanced by the smallest step required by any element in the model. As indicated by FIG. 5, this implies that most elements are forced to take unnecessarily small steps. If, instead, it were possible to allow the thermal elements to progress forward in time asynchronously, it would be possible to allow elements for which the temperature approximation function accurately matches the actual temperature over a longer time span duration to choose larger steps. Thus,
∀_{t∈Ue∈E}hₜₑ^{a}=Sₜₑ (8)
where hₜₑ^{a} is the asynchronous adaptive step size to use for element e at time t. If, at many times,

$${\sum }_{e ∈ E} {h}_{e}^{a} ⪢ \vert E \vert {h}^{s} \qquad ( 9 )$$

i.e., the average step size is much greater than the adaptive synchronous step size, as is clearly the case for the dynamic IC thermal analysis problem (see Section 2), then asynchronous element time-marching clearly holds the potential to dramatically accelerate dynamic thermal analysis compared with non-adaptive and synchronous adaptive techniques. However, reaching this potential requires that a number of problems first be identified and solved: asynchronous element time-marching increases the cost of using higher-order methods and increases the difficulty of maintaining numerical stability.
3.4.3. Impact of Asynchronous Elements on Order

Recall that thermal element temperature approximation functions depend on the temperatures of an element's (transitive) neighbors at a consistent time. Determining these temperatures is trivial in conventional synchronous time-marching techniques: all elements have the same time. However, asynchronous time-marching requires that consistency be achieved despite the differing thermal element local times.

Although many time-marching numerical methods for solving ordinary differential equations are based on methods that do not require explicit differentiation, these methods are conceptually based on repeated Taylor series expansions around increasing time instants. Revisiting these roots and basing time-marching on Taylor series expansion allows asynchronous element-by-element time step adaptation by supporting the extrapolation of temperatures to arbitrary times.

For many problems, the differentiation required for calculating Taylor series expansions is extremely complicated. Fortunately, for the dynamic IC thermal analysis problem, the problem is tractable. Noting the definitions in Equation 3, and given that Tᵢ(t) is the temperature of element i at time t, Gᵢₙ is the thermal conductivity between thermal elements i and n, Vᵢ is the volume of thermal element i, N are the element's neighbors, and M is the neighbor depth, we know that the net heat flow for a given thermal element, i, is zero.

$$\begin{matrix}0 = {\sum }_{n ∈ {N}_{ i}} ( {T}_{ i} ( t ) - {T}_{ n} \cdot u ( t ) ) {G}_{ i n} + \\ {ρ}_{i} {c}_{i} {V}_{i} \frac{ⅆ T}{ⅆ t} - {p}_{i} {V}_{i} \cdot u ( t )\end{matrix} \qquad ( 10 )$$

This can be simplified by introducing a few variables.

$$\begin{matrix}Let α = {\sum }_{n ∈ {N}_{i}} {G}_{i n} & ( 11 ) \\ Let β = {\sum }_{n ∈ {N}_{i}} {T}_{n} {G}_{i n} + {p}_{i} {V}_{i} & ( 12 ) \\ Let κ = {ρ}_{i} {c}_{i} {V}_{i} & ( 13 ) \\ 0 = T ( t ) \cdot α - u ( t ) \cdot β + κ \frac{ⅆ T}{ⅆ t} & ( 14 )\end{matrix}$$

and solved for T(t).

$$\begin{matrix}\begin{matrix}L ( T ( t ) \cdot α - u ( t ) \cdot β + κ \frac{ⅆ T}{ⅆ t} ) = T ( s ) \cdot α - 1 / s \cdot \\ β + T ( s ) \cdot s \cdot κ - \\ T ( {0}^{-} ) \cdot κ\end{matrix} & ( 15 ) \\ T ( s ) = \frac{β + s \cdot T ( {0}^{-} ) \cdot κ}{s \cdot ( α + s \cdot κ )} by 14 and 15. & ( 16 ) \\ T ( s ) = \frac{β}{s \cdot ( α + s \cdot κ )} + \frac{T ( {0}^{-} ) \cdot κ}{α + s \cdot κ} & ( 17 ) \\ Let γ = \frac{1}{s \cdot ( α + s \cdot κ )} & ( 18 ) \\ T ( s ) = \frac{T ( {0}^{-} )}{s + α / κ} + β \cdot γ & ( 19 )\end{matrix}$$

Linearity theorem for γ.

$$\begin{matrix}\frac{1}{s \cdot ( α + s \cdot κ )} = \frac{A}{s} + \frac{B}{α + s \cdot κ} & ( 20 ) \\ a = A \cdot ( α + s \cdot κ ) + B \cdot s & ( 21 )\end{matrix}$$

Let s=0 to yield A=1/α and let s=−α/κ to yield B=−κ/α.

$$\begin{matrix}γ = \frac{1}{s \cdot ( α + s \cdot κ )} = \frac{1 / α}{s} - \frac{1 / α}{s + α / κ} & ( 22 ) \\ T ( s ) = \frac{T ( {0}^{-} )}{s + α / κ} + \frac{β / α}{s} - \frac{β / α}{s + α / κ} & ( 23 ) \\ {ℒ}^{- 1} ( \begin{matrix}\frac{T ( {0}^{-} )}{s + α / κ} + \\ \frac{β / α}{s} - \\ \frac{β / α}{s + α / κ}\end{matrix} ) = u ( t ) \cdot β / α + ( T ( {0}^{-} ) - β / α ) {ⅇ}^{- t \cdot α / κ} & ( 24 ) \\ \begin{matrix}T ( t ) \\ t \geq 0\end{matrix} = β / α + ( T ( {0}^{-} ) - β / α ) {ⅇ}^{- t \cdot α / κ} & ( 25 )\end{matrix}$$

Note that, although the impact of transitive neighbors is not explicitly stated, it may be considered in higher-order methods. Thus, β should be redefined to explicitly consider transitive neighbors.

$${β}_{i} ( t , M ) = \{ \begin{matrix}{\sum }_{n ∈ {N}_{i}} {T}_{n} ( t , M ) \cdot {G}_{i n} + {p}_{i} {V}_{i} & if M > 0 \\ {p}_{i} {V}_{i} & otherwise\end{matrix} \qquad ( 26 )$$

Thus, the nearest-neighbor approximation of temperature of element i at time t+h follows.

$${T}_{i} ( t + h , M ) = {β}_{i} ( t + h , M - 1 ) / {α}_{i} + \frac{{T}_{i} ( t ) - {β}_{i} ( t + h , M - 1 ) / {α}_{i}}{{ⅇ}^{( h \cdot {α}_{i} ) / κ}} \qquad ( 27 )$$

Boundary conditions are imposed by the chip, package, and cooling solution. Note that this derivation need not be carried out on-line during thermal analysis. It is done once, for an update function and the resulting equation. It is possible to use an exact local update function, such as Equation 25, or an approximation function based on low-order Taylor series expansion. In practice, we found that a first-order approximation was sufficient for local updates, as long as the impact of transitive neighbors was considered via Equations 26 and 27.

Note that the potentially differing values of step size, h, and local time, t, for all thermal elements implies that the number of transitive temperature extrapolations necessary for an element to advance by one time step may not be amortized over multiple uses as in the case in the synchronous Runge-Kutta methods. We will contrast a conventional Runge-Kutta method with ISAC to illustrate the changes necessary for asynchronous element time-marching. For the sake of explanation, consider the fourth-order Runge-Kutta method, which is used for the purpose of comparison in Section 4.2. Given that Nᵢ is the set of block i's neighbors, pᵢ, Tᵢ, Tᵢ, and κᵢ are the power consumption, current temperature, next temperature, and heat capacity of element i; Gᵢₙ is the thermal conductivity between elements n and i; and h is the time-marching step size,

$$\begin{matrix}{d}_{{1}_{i}} = \frac{{P}_{i} - {\sum }_{n ∈ {N}_{i}} {T}_{n} {G}_{ni}}{{κ}_{i}} & ( 28 ) \\ {d}_{{2}_{i}} = \frac{{P}_{i} - {\sum }_{n ∈ {N}_{i}} \frac{( {T}_{n} + h \cdot {d}_{{1}_{n}} ) {G}_{in}}{2}}{{κ}_{i}} & ( 29 ) \\ {d}_{{3}_{i}} = \frac{{P}_{i} - {\sum }_{n ∈ {N}_{i}} \frac{( {T}_{n} + h \cdot {d}_{{2}_{n}} ) {G}_{in}}{2}}{{κ}_{i}} & ( 30 ) \\ {d}_{{4}_{i}} = \frac{{P}_{i} - {\sum }_{n ∈ {N}_{i}} ( {T}_{n} + h \cdot {d}_{{3}_{n}} ) {G}_{in}}{{κ}_{i}} & ( 31 ) \\ {T}_{i} = {T}_{i} + \frac{h}{6} ( {d}_{{1}_{i}} + 2 {d}_{{2}_{i}} + 2 {d}_{{3}_{i}} + {d}_{{4}_{i}} ) & ( 32 )\end{matrix}$$

Clearly, each element update requires the computation of all d terms. This would at first seem to imply that each element temperature update requires extrapolation of the temperatures of transitive neighbors. However, because all dᵢ₊₁ values can be computed as functions of previously-computed dᵢ values, the cost of computing dᵢ values may be amortized over many uses. This amortization allows increases in the order of Runge-Kutta and explicit synchronous time-marching methods without great increases in computational complexity. However, asynchronous thermal analysis requires the extrapolation of the temperature of a thermal element to the numerous different local times of its neighbors. This prevents the amortization described above. As a result, for three-dimensional thermal analysis using asynchronous time-marching, the number of evaluations, e, is related to the transitive neighbor count, d, as follows:
e=|E|( 4/3d³+2d²+ 8/3d) (33)

In summary, although it is common to improve the performance of time-marching techniques by increasing their orders, thereby increasing their step sizes, for the IC thermal analysis problem greater gains are possible by decoupling element local times, allowing most elements to take larger than minimum-sized steps. However, this requires explicit differentiation and prevents the amortization of neighbor temperature extrapolation, increasing the cost of using higher-order methods relative to that of using fully synchronized element time-marching techniques. As demonstrated in Section 4, this trade-off is an excellent one: the third-order element-by-element adaptation method yields speed-ups ranging from 122.81-337.23× when compared to the fourth-order adaptive Runge-Kutta method.

3.4.4. Step Size Computation

We now describe the element-by-element step size adaptation methods used by ISAC to improve performance while preserving accuracy. As illustrated in the right portion of FIG. 6, dynamic analysis starts with an initial three-dimensional temperature profile and hybrid oct-tree that may have been provided by the synthesis tool or generated by ISAC using steady-state analysis; a chip/package/ambient heat capacity and thermal conductivity profile; and a power profile. After determining the initial maximum safe step sizes of all elements, ISAC initializes an event queue of elements sorted by their target times, i.e., the element's current time plus its step size. The element with the earliest target time is selected, its temperature is updated, a new maximum safe step size is calculated for the element, and it is reinserted in the event queue. The event queue serves to minimize the deviation between decoupled element current times, thereby avoiding temperature extrapolation beyond the limits of the local time bounded-order expansions. The new step size must take into account the truncation error of the numerical method in use as well as the step sizes of the neighbors. Given that hᵢ is element i's current step size, v is the order of the time-marching numerical method, u is a constant slightly less than one, y is the error threshold, Fᵢ is element i's limited-order temperature approximation function, and tᵢ is i's current time, the safe next step size for a block, ignoring non-local effects, follows.

$${s}_{i} ( {t}_{i} ) = u \cdot {( \frac{y}{\vert {F}_{i} ( {t}_{i} ) \cdot \frac{3}{2} \cdot {h}_{i} - \frac{3}{4} \cdot {h}_{i} ( {F}_{i} ( {t}_{i} ) + {F}_{i} ( {t}_{i} + \frac{3}{4} \cdot {h}_{i} ) ) \vert} )}^{1 v} \qquad ( 34 )$$

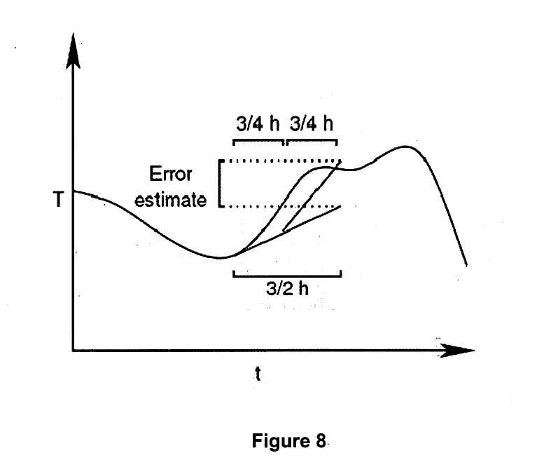

I.e., the new step size is computed by determining the absolute difference between the result of taking two ¾h steps and one 3/2h step and dividing the error threshold by this value. This is illustrated, for a first-order method, in FIG. 8. The result is then taken to the power of the reciprocal of the order of the method. Note that Equation 36 is the general expression. For the sake of example, the expression for a first-order method follows. Given that dTᵢ/dt(t) is the derivative of i's temperature with respect to time at time t,

$${s}_{i} ( {t}_{i} ) = \frac{uy}{\vert \frac{ⅆ {T}_{i}}{ⅆ t} ( {t}_{i} ) \cdot \frac{3}{2} \cdot {h}_{i} - \frac{3}{4} \cdot {h}_{i} ( \frac{ⅆ {T}_{i}}{ⅆ t} ( {t}_{i} ) + \frac{ⅆ {T}_{i}}{ⅆ t} ( {t}_{i} + \frac{3}{4} \cdot {h}_{i} ) ) \vert} \qquad ( 35 )$$

This method of computing a new step size is based on the literature [18]. However, it uses non-integer test step sizes to bracket the most probable new step size.
3.4.5. Neighborhood Time Deviation Bounds for Numerical Stability

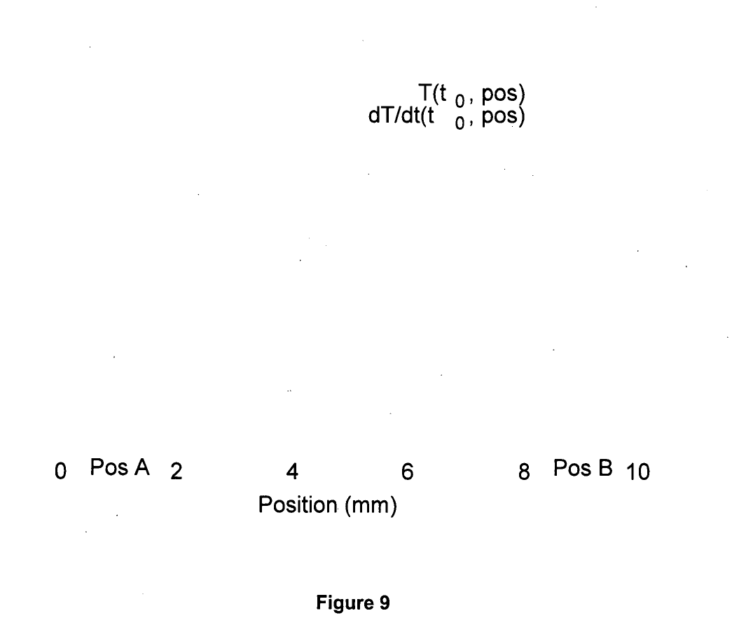

It is necessary to further bound time-marching step sizes to ensure that the local times of neighbors are sufficiently close for accurate temperature extrapolation. For the sake of example, consider the following situation illustrated in FIG. 9. To the far left of an IC active layer, at position A, the power consumption of a thermal element has recently increased. As a consequence, the temperatures of elements increase in a wave propagating rightward from position A. Note that the dashed line indicates the derivative of temperature with respect to time at time zero as a function of position, not the derivative of the temperature with respect to position.

The maximum asynchronous safe step size of an element to the far right of the IC, at position B, is large because the temperature function implied by the temperatures of other thermal elements in its neighborhood is easily approximated. For B, the rate of temperature change, based on its thermal profile of its neighborhood, is zero. Therefore, the element is marked with an update time far in the future. Unfortunately, the temperature change resulting from A's power consumption increase may reach B's neighborhood before B's marked update time. Therefore, it is necessary to constrain the deviation of the local times of immediate neighbors in order to prevent instability due to unpredicted global effects. Given that Nᵢ is the set of i's neighbors and w is a small constant, e.g., 3, the new step size follows.

$${h}_{i} = min ( {s}_{i} ( {t}_{i} ) , {min}_{n ∈ {N}_{i}} ( w \cdot ( {t}_{n} + {h}_{n} - {t}_{i} ) ) ) \qquad ( 36 )$$

For efficiency, the hₙ of a neighbor at its own local time is used.

This temporal adaptation technique based upon Equations 26, 27, and 36 is general, and has been tested with first-order, second-order, and third-order numerical methods. As indicated in Section 4.2, the result is a 122.81-337.23× speedup without loss of accuracy when compared to the fourth-order adaptive Runge-Kutta method.

3.4.6. Comments on Adaptation in Simulation and Numerical Analysis

Although the asynchronous method described in this article is new, researchers have previously considered using asynchronous agents or elements in numerical simulation. Kozyakin provides a survey of, and tutorial on, asynchronous systems focusing on distributed computational networks [19]. Esposito and Kumar describe event detection and synchronization methods to allow mostly-asynchronous simulation of multi-agent systems, e.g., multibody systems [20]. The work of Devgan and Roher on adaptively controlled explicit simulation is the most closely related to the proposed technique [21]. They propose using piecewise linear functions to model the responses of circuit elements. Instead of moving forward in time at a constant pace, each time step moves to the nearest time at which any circuit element becomes quiescent. In contrast, ISAC directly supports smooth functions, such as those appearing in the heat transfer problem, and allows step sizes to be adaptively controlled by error bounds instead of being imposed by the structure of the piecewise linear models used in the problem specifications.

3.5. Impact of Variable Thermal Conductivity

The thermal conductivity of a material, e.g., silicon, is its ratio of heat flux density to temperature gradient. It is a function of temperature, T. An ICs thermal conductivity, k(\vec{r},T), is also a function of position, \vec{r}. Most previous fast IC thermal analysis work ignores the dependence of thermal conductivity on temperature, approximating it with a constant. This introduces inaccuracy in analysis results. In contrast, ISAC models thermal conductivity as a function of temperature.

Position and temperature dependent thermal conductivity follows [22]:

$$k = {{k}_{0} ( \frac{T}{300} )}^{- η} \qquad ( 37 )$$

where k₀ is the material's conductivity value at temperature [300]° K, η is a constant for the specific material. Recalculating the thermal conductivity value after each iteration for all the elements would be computationally expensive. In order to maintain both accuracy and performance, ISAC uses a post-processing feedback loop to determine the impact of variations in thermal conductivity upon temperature profile. As described in Section 4.1, neglecting the dependence of thermal conductivity on temperature can result in a 5° C. underestimation of peak temperature.
3.6 The Use of ISAC in IC Synthesis

As explained in Section 2, ISAC was developed primarily for use within IC design, simulation, synthesis, fabrication, and/or packaging, although it may also be used to provide guidance during manual architectural decisions. ISAC may be used to solve both the steady-state and dynamic thermal analysis problems described in Section 3.1. For use in steady-state analysis, ISAC requires three-dimensional chip-package profiles of thermal conductivity and power density. The required IC power profiles are typically produced by a floorplanner used within the synthesis process [14,23,24]. In this application, it produces a three-dimensional steady-state temperature profile. When used for dynamic thermal analysis, ISAC requires three-dimensional chip-package profiles of temperature, power density, heat capacity, (optionally) initial temperature, and an elapsed IC duration after which to report results. In this application, it produces a three-dimensional temperature profile at any requested time.

Both steady-state and dynamic thermal analysis solvers within ISAC have been accelerated, using the techniques described in Sections 3.3 and 3.4, in order to permit efficient use after each tentative change to an IC power profile during synthesis or design. Use within synthesis has been validated (see Section 4) by integrating ISAC within a behavioral synthesis algorithm [14].

### 4. Experimental Results

In this section, we validate the performance of ISAC. Experiments were conducted on Linux workstations of similar performance. ISAC supports both steady-state and dynamic thermal analysis. Steady-state thermal analysis is validated against COMSOL Multiphysics, a widely-used commercial physics modeling package, using two actual chip designs from IBM and the MIT Raw group. Dynamic thermal simulation is validated against a fourth-order adaptive Runge-Kutta method using a set of synthesis benchmarks. Efficiency determines whether using adaptive thermal analysis during synthesis and design is tractable. To characterize the efficiency of ISAC, we compare it with alternative thermal analysis methods by conducting steady-state and dynamic thermal analysis on the power profiles produced during IC synthesis.

4.1. Steady-State Thermal Analysis Results

This section reports the accuracy and efficiency of the steady-state thermal simulation techniques used in ISAC. We first conduct the following experiments using two actual chip designs. The first IC is designed by IBM. The silicon die is 13 mm×13 mm×0.625 mm, which is soldered to a ceramic carrier using flip-chip packaging and attached to a heat sink. A detailed 11×11 block static power profile was produced using a power simulator. The second IC is a chip-level multiprocessor designed by the MIT Raw group. This IC contains 16 on-chip MIPS processor cores organized in a 4×4 array. The die area is 18.2 mm×18.2 mm. It uses an IBM ceramic column grid array package with direct lid attach thermal enhancement. The static power profile is based on data provided in the literature [25]. We validate ISAC by comparing its results with those produced by COMSOL Multiphysics, a widely-used commercial three-dimensional finite element based physics modeling package. Table 1 provides thermal analysis results produced by ISAC and COMSOL Multiphysics for these ICs. Average error, e_{avg} will be used as a measure of difference between thermal profiles:

$${e}_{avg} = 1 / \vert {E \vert \sum }_{e ∈ E} \vert {T}_{e} - {T}_{e}^{′} \vert / {T}_{e} \qquad ( 38 )$$

where E is the set of elements on the surface of the active layer of the silicon die modeled by ISAC. Tₑ and T′ₑ are the temperatures of element e reported by COMSOL Multiphysics (FEMLAB) and ISAC, respectively. For the sake of consistency with existing work on IC thermal analysis, percentage error is computed with the fixed point of 0° C. instead of the usual comparison to 0° K. This is conservative; if comparisons were made in degrees Kelvin instead of degrees Celsius, the reported percentage error would be substantially lower.

TABLE 1
Steady-state architectural thermal analysis evaluation

| | ISAC | | | | | | | Multigrid_HM | | | Const. k | |
|---|---|---|---|---|---|---|---|---|---|---|---|---|
| | Peak | Average | | CPU | | | | CPU | Memory | | Peak | Average |
| | temp. | temp. | Error | time | Speedup | Memory | | time | use | | temp. | temp. |
| Test cases | (° C.) | (° C.) | (%) | (s) | (x) | use (KB) | Elements | (s) | (KB) | Elements | (° C.) | (° C.) |
| IBM chip | 90.7 | 54.8 | 1.7 | 0.08 | 27.50 | 252 | 1,800 | 2.2 | 4,506 | 32,768 | 85.2 | 53.8 |
| MIT Raw | 88.0 | 81.3 | 0.7 | 0.01 | 690.00 | 108 | 888 | 6.9 | 4,506 | 32,768 | 83.1 | 77.5 |

In Table 1, the second and third columns show the peak and average temperatures of the surface of the active layer of the silicon dies of these chips, as reported by ISAC. Compared to COMSOL, the average errors, e_{avg}, are 1.7% and 0.7%. The next four columns show the efficiency of ISAC in terms of CPU time, speedup, memory use, and number of elements. For comparison, the next three columns show the efficiency of a multigrid analysis technique with homogeneous meshing. These results clearly demonstrate that element resolution adaptation allows ISAC to achieve dramatic improvements in efficiency compared to the conventional multigrid technique. ISAC achieves speedups of up to 690.00× or more relative to an efficient but homogeneous element partitioning approach. Memory usage decreases to 5.6% and 2.4% of that required by the homogeneous technique. Note that multigrid steady-state analysis itself is a highly-efficient approach [6]. Using COMSOL, both simulations take at least 20 minutes.

Existing IC thermal analysis tools typically neglect the dependence of thermal conductivity on temperature, potentially resulting in substantial errors in peak temperature. In previous work, this error was not detected during validation because the models against which they were validated also used constant values for thermal conductivity. Temperature varies through the silicon die. Therefore, ignoring the dependence of thermal conductivity on temperature may introduce significant errors. As described in Section 3.5, ISAC supports modeling of temperature-dependent thermal conductivity. The last two columns of Table 1 show the peak and average temperatures reported by COMSOL Multiphysics when the thermal conductivity at 25° C., i.e., room temperature, is assumed. It shows that, for both chips, the peak temperatures are underestimated by approximately 5° C. This effect will be even more serious in designs with higher peak temperatures. Note that the source of inaccuracy is not the specific value of thermal conductivity chosen. No constant value will allow accurate results in general: an accurate IC thermal model must consider the dependence of silicon thermal conductivity upon temperature.

To further evaluate its efficiency, we use ISAC to conduct thermal analysis for the behavioral synthesis algorithm described in Section 2. This iterative algorithm does both behavioral-level and physical-level optimization. In this experiment, ISAC performs steady-state thermal analysis for each intermediate solution generated during synthesis of ten commonly-used behavioral synthesis benchmarks.

TABLE 2
Steady-state thermal analysis in IC synthesis

| | ISAC | | | | Multigrid_HM | | HLS |
|---|---|---|---|---|---|---|---|
| | CPU | Speedup | Mem. | Error | CPU | Mem. | CPU |
| Problem | time (s) | (x) | (KB) | (%) | time (s) | (KB) | time (s) |
| chemical | 0.78 | 53.06 | 265 | 0.35 | 41.39 | 4,506 | 40.02 |
| dct_wang | 2.52 | 37.08 | 264 | 0.24 | 93.43 | 4,506 | 301.37 |
| Dct_dif | 2.40 | 37.63 | 266 | 1.50 | 90.31 | 4,506 | 71.60 |
| Dct_lee | 6.10 | 27.64 | 268 | 0.50 | 168.60 | 4,506 | 132.15 |
| elliptic | 2.31 | 32.38 | 267 | 0.43 | 74.79 | 4,506 | 38.07 |
| Iir77 | 3.35 | 29.27 | 265 | 0.20 | 98.06 | 4,506 | 77.93 |
| Jcb_sm | 1.63 | 21.64 | 277 | 0.13 | 35.27 | 4,506 | 151.95 |
| mac | 0.26 | 79.08 | 264 | 0.12 | 20.56 | 4,506 | 12.32 |
| paulin | 0.13 | 202.85 | 264 | 0.25 | 26.37 | 4,506 | 4.06 |
| Pr2 | 8.29 | 22.53 | 285 | 0.55 | 186.75 | 4,506 | 220.81 |

Table 2 shows the performance of ISAC when used for steady-state thermal analysis during behavioral synthesis. The second, third, and fourth columns show the overall CPU time, speedup, and average memory used by ISAC to conduct steady-state thermal analysis for all the intermediate solutions. Column five shows the average error compared to a conventional homogeneous meshing multigrid method, the overall CPU time and average memory use of which are shown in columns six and seven. ISAC achieves almost the same accuracy with much lower run-time. The last column shows the CPU time used by the behavioral synthesis algorithm. Comparing column two and column seven makes it clear that, when used for steady-state thermal analysis, ISAC consumes only a fraction of the CPU time required for synthesis: it is feasible to use ISAC during synthesis.

4.2. Dynamic Thermal Analysis Results

In this section, we evaluate the accuracy and efficiency of the dynamic thermal analysis techniques used in ISAC. Heterogeneous spatial resolution adaptation was evaluated via steady-state thermal analysis. We will now focus on evaluating the proposed temporal adaption technique. We apply this technique to second-order (ISAC-2nd-order) and third-order (ISAC) numerical methods, which are then used to conduct dynamic thermal analysis on power profiles produced by our thermal-aware behavioral synthesis algorithm during optimization. Efficiency and accuracy are compared with a fourth-order adaptive Runge-Kutta method, which uses global temporal adaptation. The CPU time of ISAC is also compared to the CPU time for IC synthesis.

We use the same set of benchmarks described in the previous section. To generate dynamic power profiles, on-line power analysis is conducted during synthesis using a switching activity model proposed in the literature [26]. For each architectural unit, input data with a Gaussian distribution are fed through an auto-regression filter to model the dependence of switching activity, and therefore power consumption, on operand bit position.

TABLE 3
Dynamic thermal analysis evaluation

| | ISAC-2nd-order | | | ISAC | | | ARK | HLS |
|---|---|---|---|---|---|---|---|---|
| | CPU | Error | Speedup | CPU | Error | Speedup | CPU | CPU |
| Problem | time (s) | (%) | (x) | time (s) | (%) | (x) | time (s) | time (s) |
| chemical | 79.80 | 0.01 | 135.74 | 48.19 | 0.02 | 224.75 | 10831.24 | 82.43 |
| dct_wang | 77.56 | 0.05 | 88.20 | 29.35 | 0.05 | 233.06 | 6840.83 | 110.24 |
| dct_dif | 104.47 | 0.03 | 71.02 | 57.67 | 0.02 | 128.65 | 7420.05 | 68.15 |
| dct_lee | 360.02 | 0.03 | 61.38 | 179.93 | 0.03 | 122.81 | 22097.77 | 90.51 |
| elliptic | 48.68 | 0.02 | 179.75 | 25.95 | 0.02 | 337.23 | 8750.10 | 80.79 |
| irr77 | 97.82 | 0.02 | 111.00 | 48.87 | 0.02 | 222.15 | 10857.33 | 110.01 |
| jcb_sm | 73.19 | 0.05 | 108.42 | 32.00 | 0.04 | 247.98 | 7935.64 | 160.52 |
| mac | 19.80 | 0.01 | 97.50 | 14.48 | 0.01 | 133.30 | 1930.00 | 29.05 |
| paulin | 16.20 | 0.02 | 109.83 | 10.86 | 0.02 | 163.86 | 1779.10 | 7.73 |
| pr2 | 82.65 | 0.02 | 106.82 | 34.08 | 0.03 | 259.04 | 8828.50 | 123.43 |

Table 3 shows the experimental results for dynamic thermal analysis. For each benchmark, columns two and five show the CPU time used by ISAC-2nd-order and ISAC to conduct dynamic thermal analysis for all the intermediate solutions generated by the behavioral synthesis algorithm. Column eight shows the CPU time used by the fourth-order adaptive Runge-Kutta method. In comparison, our techniques consistently speeds up analysis by at least two orders of magnitude, as indicated by column four and column seven. As shown in column three and column six, ISAC produces results that deviate from those of the adaptive fourth-order Runge-Kutta method by no more than 0.05%. The last column shows the CPU time used by the behavioral IC synthesis algorithm. As indicated in the table, it would be impractical to use the adaptive fourth-order Runge-Kutta method within IC synthesis due to its high computational overhead. The CPU times required by the proposed thermal analysis techniques are similar to those required by IC synthesis. Therefore, it is practical to incorporate them within IC synthesis.

### 5. Dynamic Thermal Analysis Techniques

This section describes TAMS, which stands for thermal analysis at multiple (time) scales. TAMS is an embodiment of ISAC that unifies spatial, time-domain, and adds frequency-domain techniques for efficient and accurate IC thermal analysis.

Static thermal analysis characterizes temperature distribution when heat flow does not vary with time. In IC designs, static thermal analysis is sufficient for applications with stable power profiles or periodically changing power profiles that cycle quickly. TAMS conducts static thermal analysis using an efficient multigrid relaxation method. In TAMS, the discretization process of IC chip and package is performed using recursive refinement, and maintained hierarchically based on discretization granularity (see Section 5.2). This adaptive refinement technique makes use of a hybrid tree structure to bound the temperature difference between adjacent elements (for accuracy) while minimizing the number of elements (for efficiency). The multigrid solver is also used for matrix inversion, as described in Section 5.4.1.

Dynamic thermal analysis characterizes run-time IC thermal profile when the transient features of power profile are significant. TAMS consists of two thermal analysis algorithms: a time marching method and a moment matching method to handle short time scale and long time scale dynamic thermal analysis, respectively. The proposed time matching method is loosely related to the adaptive Runge-Kutta method. In this method, run-time temperature changes are discretized into numerous time steps and estimated via a limited-order expansion of the actual temperature function around each time. Its computational complexity is linearly proportional to the number of time steps and elements. Short time steps are sometimes necessary for accuracy. Therefore, in TAMS, the time step magnitudes of each element is adjusted independently, allowing elements to progress forward in time asynchronously. Care is taken to prevent asynchronous deviations growing large enough to introduce error (see Section 5.3).

The proposed frequency-domain numerical method derives an approximate analytical solution, which is used to compute run-time thermal profile without the need of expensive time-domain iteration. However, deriving this analytical solution is expensive. Therefore, TAMS uses the moment matching method for long time scale dynamic thermal analysis in which the cost of deriving the analytical approximation may be amortized (Section 5.4).

The major challenges of numerical IC thermal analysis are high computational complexity and memory usage. Stringent modeling accuracy constraints require fine-grain discretization, resulting in numerous grid elements. For multigrid-based static thermal analysis, both computational complexity and memory usage are superlinearly proportional to the number of thermal grid elements. For dynamic thermal analysis using the time matching method, higher modeling accuracy requires the reduction of both spatial and temporal discretization granularities, which increases the computational overhead of this method quadratically. For dynamic thermal analysis using moment matching, deriving initial analytical approximations is both computation and memory intensive. Fine-grain discretization may serious challenge, or prevent, the applicability of this frequency-domain method. In addition, the time complexity of this method increases linearly with increasing simulation time scale.

5.1. Numerical Thermal Analysis Basics

TAMS characterizes the heat diffusion process through the IC chip and cooling package. Thermal conduction heat diffusion is governed by the following partial differential equation.

$$ρ {c}_{p} \frac{\partial T ( \vec{r} , t )}{\partial t} = “ ( k ( \vec{r} ) ” T ( \vec{r} , t ) ) + p ( \vec{r} , t ) \qquad ( 39 )$$

where ρ is material density; cₚ is mass heat capacity; T(\vec{r},t) and k(\vec{r}) are temperature and thermal conductivity of the material at position \vec{r} and time t; and p(\vec{r},t) is heat source power density.

To conduct numerical thermal analysis, the IC chip and package are partitioned into numerous elements through a discretization process. The distributed thermal characteristics of the IC, heatsink and package are then modeled using finite difference discretization in which each element is a node connected to neighboring elements via thermal resistors and connected to a node at the ambient temperature via a thermal capacitor. Thus,
CT(t)′=AT(t)+PU(t) (40)
where the thermal capacitance matrix, C, is an [N×N] diagonal matrix; the thermal conductivity matrix, A, is an [N×N] sparse matrix; T(t) and P(t) are [N×1] temperature and power vectors; and U(t) is the time step function. As we return to the roots of this formalism, it is interesting to note that Georg Simon Ohm's work on current conduction in circuits [27] was based on Fourier's study of heat transfer.
5.2. Static Analysis and Spatial Adaptation

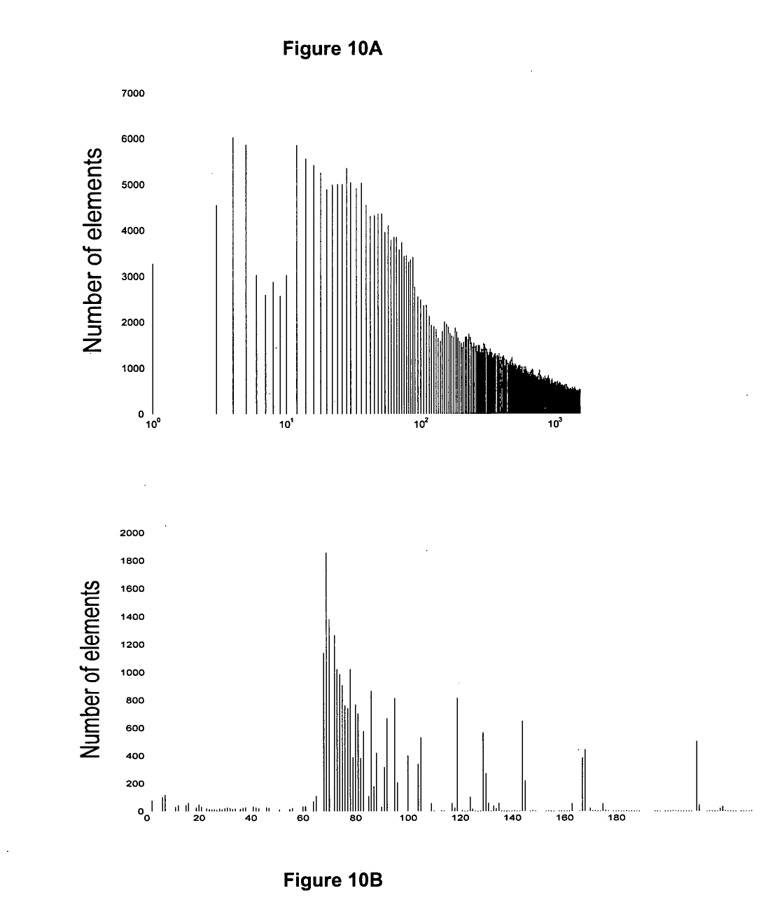

During thermal analysis, both time complexity and memory usage are linearly or superlinearly related to the number of thermal grid elements. Therefore, it is critical to limit the discretization granularity. IC thermal profile contains significant spatial variation due to the heterogeneity of thermal conductivity and heat capacity in different materials, as well as the variation of power profiles. FIG. 10(a) shows the normalized inter-element temperature differences using static thermal analysis of an IC implementing a digital signal processing benchmark. The wide distribution of temperature differences shown in this figure motivated us designed an efficient, thermal gradient driven, adaptive spatial discretization refinement technique that automatically adjusts the spatial partitioning resolution to maximize thermal modeling efficiency and guarantee modeling accuracy. This technique dramatically improves the efficiency of frequency-domain and time-domain thermal analysis.

In this technique, the spatial discretization process is governed by temperature difference constraints. Iterative refinement is conducted in a hierarchical fashion. Through each iteration, temperature approximation is performed until convergence to a stable profile. Neighboring grid elements with temperature differences exceeding thermal difference constraints are recursively partitioned. Given adjacent thermal element temperatures, Tᵢ and Tⱼ, and the spatial thermal difference constraint, S, the number of partitions for these two elements is abs(Tᵢ−Tⱼ)/S. The position of each individual cut is a function of the thermal conductivities and the sizes of the elements. Using hierarchical partitioning, ┌log₂(Tᵢ−Tⱼ/s)┐ cuts are required.

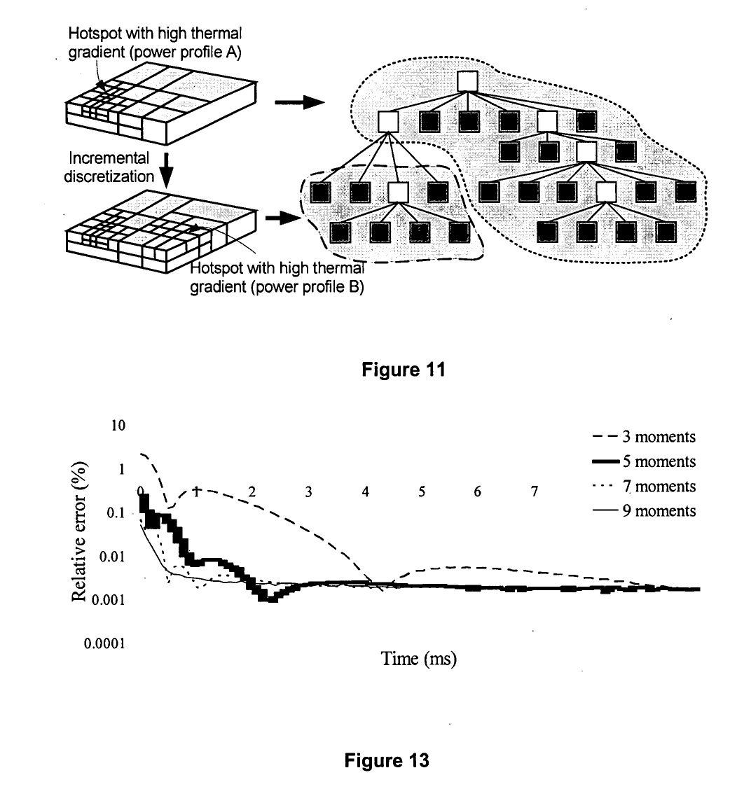

Spatial discretization refinement takes all input power profiles into consideration through incremental refinement. As shown in FIG. 11, the initial spatial refinement is based on the input power profile A. A hotspot occurs at bottom-left corner of the chip active layer, increasing the thermal gradient in that region. As a consequence, finer-granularity spatial discretization is used in that region. Power profile B is later examined, causing further refinement of a region near the right of the chip. For each thermal element, partitioning decisions are based on the maximum difference between neighboring elements over the static thermal profiles associated with all power profiles in the trace provided for analysis.

To support incremental spatial discretization refinement, we propose the efficient hybrid tree structure illustrated the right side of FIG. 11. This structure provides an efficient representation of the incremental refinement process, which refers to the incremental growth of the tree. In this hybrid tree, all the leaf nodes, shown as grey blocks in FIG. 11, refer to the thermal grid elements used in dynamic thermal analysis. This hybrid tree structure also provides an efficient hierarchical representation for multigrid analysis, by enabling efficient traversal through different levels of the tree.

5.3. Asynchronous Time Marching Method

The time marching technique used in TAMS shares some attributes with the Runge-Kutta family of finite difference techniques [17]. When Runge-Kutta time marching techniques are used for thermal analysis, thermal elements advance in time in lock step. At each time step, the temperature at a fixed time offset is computed via a bounded-order function approximating the element's true temperature. This function is a reformulation of the Taylor series expansion of the thermal element's temperature function around its current time. An element's bounded-order function depends on the thermal conductivities, heat capacities, and temperatures of its neighboring thermal elements and, in the case of functions with orders greater than one, its transitive neighbors. The time complexity of this method is bounded by amortizing computations over use by many (transitive) neighbors, permitting the use of high-order methods. Using higher-order methods is considered, by most, to be wise because it allows the bounded-order approximation function to accurately approximate the real temperature over long time scales, thereby allowing large time steps and speeding analysis.

There are two categories of Runge-Kutta methods: non-adaptive and adaptive. Non-adaptive Runge-Kutta methods use the same time step size throughout analysis. Unfortunately, this means that performance is bounded by the smallest time step required by any element at any time. A fourth-order non-adaptive Runge-Kutta method has been used for dynamic IC thermal analysis [5].

We found that non-adaptive fourth-order Runge-Kutta techniques were incapable of handling thermal models with enough discrete elements to permit accuracy, while running with adequate performance for use within IC synthesis. It is possible to improve performance substantially without loss of accuracy by using an adaptive fourth-order Runge-Kutta technique in which thermal elements advance in time in lock-step but, at each time, the step size is adjusted to the minimal size required for accuracy by any thermal element. The adaptive fourth-order Runge-Kutta method appears to be near a local optimum, performing better than lower-order and non-adaptive Runge-Kutta techniques without loss of accuracy. However, we have found it to be far from the global optimum for IC thermal analysis.

FIG. 10(b) is a histogram illustrating the distribution of maximum step sizes satisfying a temperature error bound of [1×10⁻⁵]° K at a single time during the time-domain thermal analysis of the same benchmark used in FIG. 10(a). In this figure, the time step sizes are normalized to the minimum over all thermal elements. The potential of allowing most thermal elements to take time steps larger than the minimum has the potential to greatly improve efficiency. TAMS uses a temporally and spatially adaptive asynchronous element time marching technique for short time scale dynamic thermal analysis. Instead of advancing all thermal elements forward in time synchronously, our method allows thermal elements to advance asynchronously. In addition, it uses a heterogeneous thermal element grid to minimize the number of thermal elements under a constraint on neighboring thermal element temperature differences (see Section 5.2).

Recall that computing the next temperature of a thermal element requires knowledge of the temperatures of (transitive) neighbors at the element's current time. This poses no special problem for conventional finite difference techniques. However, allowing asynchronous thermal element times makes it necessary to extrapolate the temperatures of an element's (transitive) neighbors to the local time of the element in order to compute the element's next temperature using a bounded-order approximation function. This prevents the amortization of temperature computations over multiple (transitive) neighbors (which was permitted by the Runge-Kutta methods). In other words, asynchronous element times make high-order approximation methods more computationally expensive. However, asynchronous operation relaxes the constraint that each step size be bounded by the minimum step size required by any element be used for all elements. For the dynamic thermal analysis problem, the gains possible via asynchronous step size adaptation hugely outweigh the disadvantages of using a lower-order approximation function. While maintaining an error lower than 0.45%, the proposed approach improves performance by at least 1.071× over fourth-order adaptive Runge-Kutta (see Section 6).

We now give the detailed thermal element temperature update and step size control expressions for the proposed asynchronous adaptive time marching technique. Given that Tₙ(t) is the temperature of element n at time t; Gᵢₙ is the thermal conductivity between elements i and n; Jᵢ are element i's neighbors; D is the neighbor depth; ρ is the material density; cₚ is the mass heat capacity; p is the power density of a heat source; V is the volume of a discrete element; s is the duration of a time step; αᵢ=Σ_{j∈J}_{ᵢ}Gᵢₙ; and

$${β}_{i} ( t , M ) = \{ \begin{matrix}{\sum }_{j ∈ {J}_{i}} {T}_{n} ( t , D ) \cdot {G}_{ij} + {Vp}_{i} & if D \neq 0 \\ {Vp}_{i} & otherwise\end{matrix} \qquad ( 41 )$$

the nearest-neighbor approximation of temperature of element i at time t+s follows

$${T}_{i} ( t + s , D ) = {β}_{i} ( t + s , D - 1 ) / {α}_{i} + \frac{{T}_{i} ( t ) - {β}_{i} ( D - 1 ) / {α}_{i}}{{ⅇ}^{( s \cdot {α}_{i} ) / ( ρ {c}_{pi} V )}} \qquad ( 42 )$$

under boundary conditions determined by the chip, package, and cooling solution. Thermal elements are selected for temperature updates using an event queue ordered by smallest element target time.

The new step size must take into account the truncation error of the numerical method in use as well as the step sizes of the neighbors. Given that sᵢ is element i's current step size, v is the order of the time-marching numerical method, u is a constant slightly less than one, y is the error threshold, dTᵢ/dt(t) is the derivative of i's temperature as a function of time at time t, and tᵢ is i's current time, the safe next step size for a block, follows.

$${s}_{i}^{+} ( {t}_{i} ) = u \cdot \frac{1}{y} {\vert \frac{ⅆ {T}_{i}}{ⅆ t} \frac{3 {t}_{i} {h}_{i}}{2} - \frac{3 {h}_{i}}{4} ( \frac{ⅆ {T}_{i}}{ⅆ t} {t}_{i} + \frac{ⅆ {T}_{i}}{ⅆ t} ( {t}_{i} + \frac{3 {h}_{i}}{4} ) ) \vert}^{- 1 v} \qquad ( 43 )$$

This method of computing a new step size is based on the literature [18]. Note that the step size must be further bounded to within a small integer multiple of the step sizes of neighboring elements to ensure robustness.

5.4. Moment Matching Algorithm for Thermal Analysis

Algorithm 4. Moment matching for dynamic thermal analysis

Require: Chip-package region thermal conductivities
Require: Chip-package region heat capacities
Require: Time series of active layer power profiles
Ensure: Time series IC temperature profiles
1: subtask Moment matching {Expensive: Amortized over many uses}
2: Homogeneous discretization of IC
3: Spatial adaptation: Minimize elements, bound temperature difference
4: Multigrid technique for fast conductivity matrix inversion
5: Moment matrix calculation via iterated multiplication and extraction
6: Eigen decomposition
7: Compute poles
8: Compute system response matrix, H
9: end subtask
10: subtask Periodic computation {Moderate cost and frequency}
11: Compute element power, initial temperature coefficient matrix
12: end subtask
13: subtask Dynamic time-domain calculations {Inexpensive but frequent}
14: Convert to time-domain representation
15: end subtask

This section describes the design and analysis of an efficient and accurate frequency-domain IC thermal analysis algorithm. As dynamic thermal analysis may be conducted via time marching techniques as well as frequency-domain moment matching, each technique is appropriate under certain circumstances. In this section, we will focus on moment matching, as this technique can result in the most dramatic improvements in analysis time, making it possible to track the temperature profile of an IC over a long time span.

Moment matching based thermal analysis is composed of three stages: static, periodic, and dynamic. The static analysis phase need be completed only once for a (potentially long) series of power profiles. In this phase, the reduced order thermal model for the chip, package, and heat sink is generated. The periodic phase occurs each time a change is reported in the power profile of the IC active layer, e.g., every 1 ms-100 ms in normal applications. In this phase, the moments of the reduced order model are used to compute system response coefficients that will be used to determine temperature profile as a function of time. In the final dynamic phase, the time-varying thermal profile of the IC is computed based on the system response coefficients.

5.4.1. Partitioning and Multigrid Analysis

We initially use the adaptive grid refinement technique described in Section 5.2 to spatially discretize the chip, package, and heatsink. This technique is of critical importance to permit moment matching to deal with large problem instances. It preserves detail in the most accuracy-critical regions, while coarsening the grid resolution in regions within which temperature will be more uniform.

In the moment matching method, the first step is using the Laplace transform to derive the frequency domain form of the heat transfer equation (Equation 40), as follows:
C(sT(s)−T(0⁻))=AT(s)+P/s
T(s)=−A⁻¹(I−sCA⁻¹)⁻¹(P/s+CT(0⁻)) (44)

Inverting the thermal conductivity matrix, A, is the first step in moment matching. This step is one of the most critical for performance due to the size of A. We have developed a hybrid, heterogeneous multigrid-based iterative relaxation technique for solving large discretized partial differential equations that is used for matrix inversion and static thermal analysis. This technique is motivated by the following observations. Accurate thermal analysis with fine-grain discretization results in a large A matrix. Inverting large matrices on typical workstations with direct methods is impractical. For example, on a workstation with 2.2 GHz Athlon processor with 1 GB of memory, attempts to invert 8,192×8,192 element matrix with LU decomposition fail due to memory constraints. Unfortunately, as shown in Section 3, IC thermal analysis frequently requires the inversion of matrices containing tens of millions of elements. In the A matrix, each non-zero value refers to the thermal conductivity between two neighboring thermal elements. Each thermal element has few neighbors, e.g., six in homogeneous partitioning. Therefore, A is sparse. However, spatial adaptation results in a highly irregular matrix representation. Efficient solvers for band matrices, such as Cholesky factorization, are not applicable. The preconditioned conjugate gradient method is an efficient solver for sparse matrices. However, experiments show that, if the number of iteration steps required for convergence is much less than N, the number of grid elements, our multigrid iterative method is more than ten times faster than the preconditioned conjugate gradient method. Moreover, the hierarchical structure of the chip-package discretization naturally matches the nested iteration of multigrid method. By iteratively traversing the discretization refinement hierarchy, our multigrid method speeds convergence.

Algorithm 5 describes the proposed multigrid iterative relaxation technique used for matrix inversion. Lines 4-16 show the multigrid relaxation kernel. To invert matrix A, through each iteration i, the solver is invoked to compute AX=eᵢ, in which eᵢ is the i th column of identity matrix I. The solution X corresponds to the ith column of matrix A⁻¹, the inversion matrix of A. Note that, for static thermal analysis, the multigrid relaxation kernel is invoked only once. If eᵢ is replaced by P, the input power profile, the solution, X, is the steady-state temperature profile.

Algorithm 5. Multigrid matrix solver

Require: matrix A
Ensure: B = A⁻¹
1: for 0 ≦ i < N do
2: Define problem AX = eᵢ
3. Pre-smoothing step: Iteratively relax initial random solution.
4: subtask coarse grid correction
5: Compute residue from finer grid.
6: Approximate residue in coarser grid.
7: Solve coarser grid problem using relaxation.
8: if coarsest level has been reached then
9: Directly solve problem at this level.
10: else
11: Recursively apply the multigrid method.
12: end if
13: Map the correction back from the coarser to finer grid.
14: end subtask
15: Post smoothing step: Add correction to solution at finest grid level.
16: Iteratively relax to obtain the final solution.
17: B[i] = X
18: end for

Despite its high efficiency relative to other direct and indirect solvers, the proposed multigrid relaxation method is still computation intensive. Its execution time is a superlinear in N, the number of rows of the matrix. For matrix inversion, the multigrid solver is invoked N times; for large problem instances, matrix inversion is a major performance bottleneck in moment matching.

It is interesting to note the impact of the error bounds used in the multigrid solver used for matrix inversion on the overall quality of the moment matching technique. Higher-order moments are more sensitive to the errors in matrix inversion than lower-order moments. Experimental results indicate that error bounds can be relaxed to 1×10⁻⁵ without introducing more than 0.01% error in the first 10 moments. In practice, only the first 8-10 moments are necessary for accurate IC thermal analysis. Therefore, careful selection of error threshold for matrix inversion has potential to allow performance enhancement in IC thermal analysis.

5.4.2. Moment Matrix Calculation Via Iterated Matrix Multiplication

The second time-critical step in moment matching is the calculation of the moment matrix, M. This matrix is composed of the first columns of matrices F₁, F₂, . . . , F_{Q} where Q is the number of moments to which the model will be reduced. A is the N×N thermal conductivity matrix and C is the N×N, diagonal, heat capacity matrix.

$${∀}_{i = 0}^{Q - 1} {F}_{i} = - {{A}^{- 1} ( {CA}^{- 1} )}^{i} \qquad ( 45 )$$

This matrix exponentiation can be reduced to a series of multiplications, each of which is necessary to compute the previous F matrix. However, each F is a dense N×N matrix and a multiplication is required for each moment. The time cost for this stage, using classical matrix multiplication, is QN³. There exist fast matrix multiplication algorithms such as Winograd's n^{2.376} timevariant [28] of Strassen's method that might reduce the time complexity to O(Q N^{2.376}). However, we tested the GEMMW implementation [29] of this technique and found that it took at least twice as long as the AMD core math library (ACML) [28] multiplication routines for values of N up to 4,096: we conclude that computing M is expensive. This emphasizes the importance of spatial partitioning algorithm described in Section 5.2 for increasing efficiency by reducing N.

As shown in FIG. 13 we have found that 8-10 moments are sufficient for high accuracy. Although selecting an appropriate number of moments, Q, to permit accuracy without degrading performance is an interesting problem, it is less critical to the static phase of moment matching than controlling the number of thermal elements. In moment matching, a few time-consuming operations require time linear in Q. In practice, the Q required for accurate analysis is bounded by a small integer. This is fortunate, as problems with numerical precision for many moment matching techniques prevent accurate calculation of more than 10-15 moments. Therefore, designers can be somewhat conservative when selecting Q, knowing that they will suffer, at most, a linear penalty in run time for this phase of moment matching. The impact of moment count on subsequent phases of thermal analysis is, however, significant and will be discussed in Section 5.4.4.

At this stage, eigen decomposition is used to determine the poles of the reduced thermal system. Fortunately, only a Q×Q matrix need be decomposed. Before eigen decomposition, it is useful to use Gram-Schmidt orthogonalization to ensure numerical stability and prevent imaginary components in the poles. As a practical consideration, designers may want to eliminate small imaginary components introduced to the poles as a result of numerical error: the system under consideration is not oscillatory.

By using the F matrices and the resulting poles, the coefficients of the frequency domain response of thermal element x corresponding to the power element j, can be calculated as follows.

$$[ \begin{matrix}- 1 / {p}_{0} & - 1 / {p}_{1} & ⋯ & - 1 / {p}_{q - 1} \\ - 1 / {p}_{0}^{2} & - 1 / {p}_{1}^{2} & ⋯ & - 1 / {p}_{q - 1}^{2} \\ ⋯ & ⋯ & ⋯ & ⋯ \\ - 1 / {p}_{0}^{q} & - 1 / {p}_{1}^{q} & ⋯ & - 1 / {p}_{q - 1}^{q}\end{matrix} ] [ \begin{matrix}{H}_{x , 1 , j} \\ {H}_{x , 2 , j} \\ ⋯ \\ {H}_{x , q - 1 , j}\end{matrix} ] = [ \begin{matrix}{m}_{0 ( x , j )} \\ {m}_{1 ( x , j )} \\ ⋯ \\ {m}_{q - 1 ( x , j )}\end{matrix} ] \qquad ( 46 )$$

The frequency domain response of thermal element x can be expressed by the coefficients h and the poles as follows.

$${T}_{x} ( s ) = ( {\sum }_{i = 0}^{q - 1} \frac{{h}_{xi}}{s - {p}_{i}} ) ( \frac{P + CT ( {0}^{-} ) s}{s} ) \qquad ( 47 )$$

For each pole, one thermal element has N coefficients, which correspond to the N power elements. The preceding equations must be solved N×N times to derive the complete set of system response function coefficients. Therefore, the time complexity of these calculations is Q²N². At this point, the static moment matching phase is complete, and need not be carried out again for the given chip, package, heatsink, and (potentially long) series of power profiles.
5.4.3. Periodic Phase: Power and Initial Temperature Dependent Coefficient Computation

The computation of system response coefficients is expensive because, for each of the N thermal elements, it is necessary to iterate over N×Q matrix entries, where Q is the number of moments. This is potentially costly. One might attack the problem by attempting to adapt Q depending on the required number of moments for each element. However, independently reducing the number of moments used in the computation of the system response coefficients without changing the poles of the system would introduce substantial error because the values of all poles depend on the number of moments used to approximate the system response. Instead, one might consider clustering to reduce the complexity of computing system response coefficients by reducing the number of thermal elements considered by each output port. In conventional circuit analysis, related techniques appear to hold some promise [30]. However, the properties of the thermal analysis problem limit the application of input port and output port reduction.

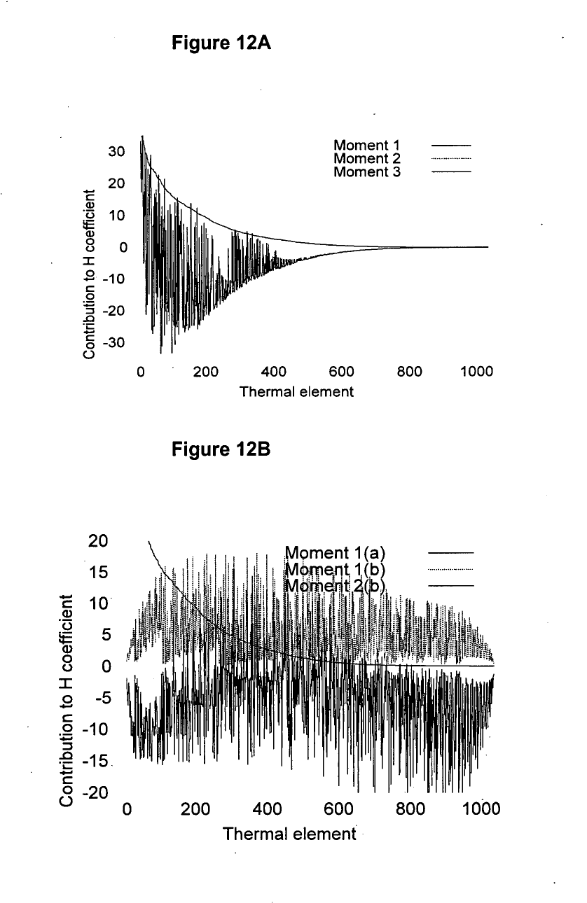

FIG. 12(a) displays the portion of each thermal element's contribution to the response coefficient of a single thermal element (an output port) that may be attributed to each of the first three moments of a ten-moment reduced-order model of a data-flow dominated signal processing benchmark. The output port under consideration is located near the top-left of the active layer. The thermal elements have been sorted in decreasing order of the contributions of the first moment to the output port. This figure implies that there may be an opportunity to cluster, or lump, the contributions associated with the first moment and different thermal element. For example, numerous elements have first-moment contributions that are similar. Moreover, in the region of greatest similarity (thermal elements 600-1024), the contributions of the second and third moments are also self-similar. This implies that one might cluster higher-index elements together once, and repeatedly make use of the cluster in periodic system response coefficient computation, thereby reducing its time complexity from Q N² to QN′², where N′ is number of clusters generated. However, the benefits of input port clustering are illusory due to the structure of the thermal analysis problem.

Recall that every thermal element intersecting with the IC active device layer is an input port of the system. Under normal circumstances, these elements are also output ports because designers and synthesis algorithms typically use thermal profiles to estimate device reliability and leakage power consumption. Input port clustering is useful for problems in which the response of multiple output ports to stimuli on some set of input ports is indistinguishable. However, in the IC thermal analysis problem, every output port has a different set of nearest-neighbor input ports, i.e., the set of input ports over which the response of an output port is symmetric differs for every output port in the thermal analysis problem.

FIG. 12(b) shows data analogous to FIG. 12(a). However, in this case, the contributions to system response coefficients are shown for the first moment of an output port near the top-left of the IC active layer (Moment 1(a)) and the first two moments of an output port near the bottom-right of the IC active layer (Moment 1(b) and Moment 2(b)). As in FIG. 12(a), the thermal elements share the same ordering on the horizontal axis. This figure clearly shows that the appropriate clusters for output ports (a) and (b) are completely different. In order for uniform clustering of the thermal elements contributing to both output ports to be feasible, the plots for both ports would need to be smooth for some shared ranges. Using a separate set of clusters for each output port would be of little value because iterating over all power and voltage values for each output port would still be necessary when computing the system response. Therefore, we conclude that input and output port clustering are inappropriate for use in moment matching based IC thermal analysis.

5.4.4. Dynamic Phase: Time Domain Temperature Computation.

During this phase, the temperature profile of the IC is calculated at (any) time. This phase requires Q×n operations to determine the temperature of each thermal element, in which n is the number of elements under observation. Within the time span of each power profile, the run-time temperature of each element can be computed directly without the need of iteration. This is the reason for the superior performance of frequency-domain techniques, over time-domain techniques, in long time scale thermal analysis. Moreover, in some synthesis and architecture applications, only a subset of active-layer thermal elements need be observed, i.e., n can be much smaller than N.

### 6. Experimental Results

In this section, we evaluate the accuracy and performance of TAMS. Experiments were conducted on a Linux workstation with a 2.1 GHz Athlon processor and 1 GB of memory. TAMS is a unified thermal analysis platform containing a static analysis technique, i.e., a spatially adaptive multigrid iterative method, and two dynamic analysis techniques, i.e., a spatially and temporally adaptive asynchronous time matching method for short time scales and a spatially adaptive moment matching method for long time scales. Due to space constraints, we focus on evaluating the proposed dynamic thermal analysis techniques. The proposed static thermal analysis method was validated in previous work. When used for thermal analysis of chip designs from IBM and the MIT Raw group, the results of our heterogeneous multigrid solver deviated from those of COMSOL Multiphysics software package (formerly FEMLAB) [8] by less than 1%. To evaluate the performance of the proposed dynamic thermal analysis techniques, we use a set of IC design benchmarks. Each benchmark provides detailed chip and package design and run-time power profiles,

6.1. Asynchronous Time Matching Method

First, we evaluate the performance of the proposed adaptive asynchronous time matching method implemented in TAMS, which is a third-order numerical method incorporating both spatial and temporal adaption techniques. To demonstrate the effectiveness of these two techniques, we compare our proposed method with a fourth-order adaptive Runge-Kutta method (GARK4), which uses global temporal adaptation with homogeneous partitioning.

Table 4 shows the experimental results for the proposed adaptive asynchronous time matching method. For each benchmark, each technique does thermal analysis for 1 ms with initial time step size of 10 ns and a temperature error bound of 1×10⁻⁵° K. For each benchmark, columns two and six show the CPU time used by TAMS and GARK4. TAMS consistently speeds up dynamic analysis by three orders of magnitude (column three), and reduces memory usage by 5.6-14.4× (column four and column seven). This high performance gain results from the unifying the proposed spatial and temporal adaptation techniques. As shown in column five, the maximum deviation of the results of TAMS from those of the GARK4 method is less than 0.45%.

TABLE 4
Results for asynchronous time matching method

| | TAMS | | | | GARK4 | |
|---|---|---|---|---|---|---|
| | CPU | Speedup | Mem. | Error | CPU | Mem. |
| Problem | time (s) | (x) | (KB) | (%) | time (s) | (KB) |
| chemical | 1.35 | 1354 | 463.47 | 0.13 | 1827.41 | 4,506 |
| Dct_wang | 0.39 | 1457 | 312.64 | 0.09 | 568.22 | 4,506 |
| dct_dif | 0.40 | 1807 | 332.91 | 0.05 | 722.64 | 4,506 |
| dct_lee | 0.85 | 1071 | 439.22 | 0.04 | 910.88 | 4,506 |
| elliptic | 2.24 | 1361 | 412.23 | 0.02 | 3042.61 | 4,506 |
| iir77 | 0.86 | 1521 | 803.09 | 0.08 | 1305.25 | 4,506 |
| jcb_sm | 0.58 | 1890 | 357.30 | 0.11 | 1092.98 | 4,506 |
| mac | 1.65 | 1105 | 403.47 | 0.45 | 1817.71 | 4,506 |
| paulin | 0.77 | 1439 | 354.28 | 0.18 | 1111.68 | 4,506 |
| pr2 | 1.06 | 1831 | 489.36 | 0.35 | 1932.95 | 4,506 |

6.2. Adaptive Moment Matching Method

We next evaluate the performance of the proposed spatially-adaptive moment matching method. This technique is for use in time scale thermal analysis of large problem instances, making validation a challenging problem. HSPICE failed to produce results for either of the benchmarks used in this work. We know of no other IC techniques capable of dynamic thermal analysis for the time scales, and problem instance sizes, handled by TAMS. Therefore, to compare with other techniques, it is necessary to bound problem instance sizes. For designs with 32 thermal elements, the proposed method produces results that differ from those of HSPICE by less than 1%.

We have characterized the analysis accuracy of the moment matching method as a function of number of moments and the time scale using the set of benchmarks described in Section 6.1. For each benchmark, a 100 ms simulation is performed using the proposed method with different moment counts: from one moment to ten moments. By using tight error bound during numerical analysis, i.e., an error bound of 1×10⁻¹⁵ for matrix inversion, analysis using ten moments is highly accurate, and serves as a base case with which analysis with fewer moments may be compared. FIG. 13 shows relative temperature error as a function of moment count and time averaged over a set of ten power profile transitions. For the sake of clarity, results using three, five, seven, and nine moments are plotted. As shown in this figure, as the number of moments increases, the relative error decreases superlinearly. For five or more moments, run-time analysis error after 1 ms is consistently less than 0.01%, relative to the ten-moment case, i.e., the frequency-domain approach achieves high analysis accuracy for long time scale analysis. Note that the proposed time-domain technique has low startup overhead and can be used for accurate short time scale thermal analysis.

Table 5 shows detailed CPU times for the adaptive moment matching technique. Note that the static phase of moment matching is computation and memory intensive. TAMS greatly improves computation and memory efficiency via spatial adaption. Without spatial adaption, the moment matching method would be unable to handle these benchmarks using the original 32K homogeneous partitioning. In this table, columns three to five show the CPU times of the three performance bottleneck in the static phase, i.e., A matrix inversion, moment matrix (M) computation, and system response (H) coefficient computation, respectively. The CPU times associated with one moment are reported. Based on the analysis in Section 5.4, with an increase of number of moments, the CPU time of matrix inversion may or may not increase depending whether a more stringent error bound must be applied, the CPU time of moment matrix computation increases linearly, and the CPU time of H coefficient computation increases quadratically. As we can see, the static phase is computation intensive. However, its cost is amortized over a long time scale. Column six shows the CPU time of the periodic phase. Compared to the proposed time-domain method, the periodic phase is fairly efficient. This phase need only be performed once for every new power profile; for long time scale power profiles, this overhead is low. Column seven shows the CPU time of the dynamic phase for each element, which is much more efficient than the proposed time-domain method. These results demonstrate that the proposed adaptive moment matching method is well-suited for long time scale thermal analysis. Using a simple design case, in which the power profile is updated with a period of 10 ms-100 ms and temperature is reported every 100 us for elements on the active layer of the silicon chip, the adaptive moment matching technique can achieve one or two orders of magnitude speedup compared to the proposed time-domain technique.

In summary, these results demonstrate that the adaptive time matching method, combined with the adaptive moment matching method, provides a highly efficient and accurate multiple time scale thermal analysis solution.

TABLE 5
Efficiency of adaptive moment matching method

| | | Static | Static M | Static H | Periodic | Dynamic |
|---|---|---|---|---|---|---|
| Problem | Elts. | A⁻¹ (s) | mul. (s) | coeff. (s) | (ms) | (μs) |
| chemical | 3,383 | 93.44 | 16.53 | 0.80 | 104.35 | 0.26 |
| dct_dif | 2,282 | 32.28 | 8.54 | 0.42 | 55.37 | 0.20 |
| dct_lee | 2,430 | 42.23 | 7.78 | 0.40 | 50.91 | 0.18 |
| dct_wang | 3,206 | 371.31 | 23.39 | 0.84 | 106.25 | 0.20 |
| elliptic | 3,009 | 194.44 | 19.46 | 0.74 | 91.31 | 0.20 |
| iir77 | 5,862 | 509.74 | 214.84 | 19.58 | 359.65 | 0.21 |
| jcb_sm | 2,608 | 125.93 | 12.63 | 0.58 | 72.45 | 0.20 |
| mac | 2,945 | 221.84 | 17.93 | 0.72 | 90.51 | 0.19 |
| paulin | 2,586 | 66.21 | 8.47 | 0.42 | 54.25 | 0.18 |
| pr2 | 3,572 | 287.97 | 31.98 | 1.06 | 132.92 | 0.20 |

### 7. Example

### Temperature-Dependent IC Leakage Power Estimation

7.1. Introduction

As a result of continued IC process scaling, the importance of leakage power consumption is increasing [31]. Leakage accounts for 40% of the power consumption of today's high-performance microprocessors [32]. Power consumption, temperature, and performance must now be optimized during the entire design flow. Leakage power consumption and temperature influence each other: increasing temperature increases leakage and vice versa. Leakage power estimation is frequently used in IC synthesis, within which it may be invoked tens of thousands of times: it must be both accurate and fast.

Researchers have developed a variety of techniques to characterize IC leakage power consumption, ranging from architectural level to device level [33]-[38]. However, most of these techniques neglect the dependence of leakage on temperature.

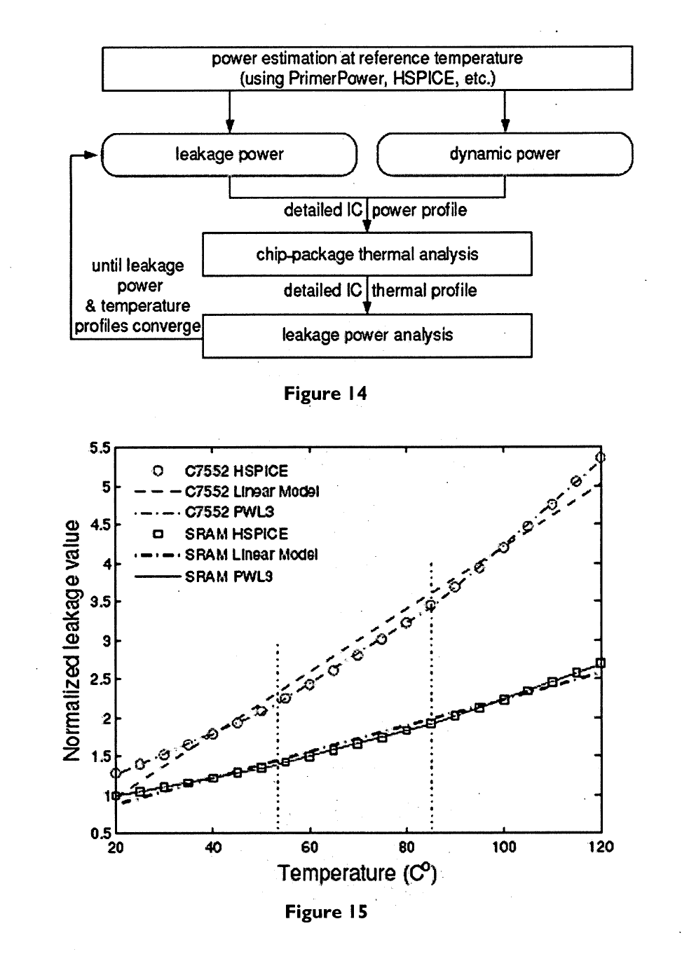

Leakage is a strong function of temperature. Therefore, thermal analysis must be embedded within the IC power analysis flow. FIG. 14 shows a typical temperature-dependent IC leakage power estimation flow. Power consumption, including dynamic power and leakage power, is initially estimated at a reference temperature. The estimated power profile is then provided to a chip-package thermal analysis tool to estimate circuit thermal profile. This thermal profile is, in turn, used to update circuit leakage power estimation. This iterative process continues until power and temperature converge.

Recent work has considered the impact of temperature on leakage. Zhang et al. developed HotLeakage, a temperature-dependent cache leakage power model [39]. Su et al. proposed a full-chip leakage modeling technique that characterizes the impact of temperature and supply voltage fluctuations [40]. Liao et al. presented a temperature-dependent microarchitectural power model [41]. In leakage analysis, one can be confident of an accurate result by using a fine-grained thermal model. However, this is computationally intensive. One can also use a coarse-grained thermal model. Although fast, previous work has not demonstrated that this will permit accurate leakage estimation. Designers may select modeling granularity. However, without an understanding of the requirements necessary for accurate leakage prediction conservative designers are forced to use slow, fine-grained thermal models. This hinders the use of accurate IC leakage power estimation during IC synthesis.

In this example, a very fast, accurate method of estimating IC leakage power consumption is presented.

1) We demonstrate that, within the operating temperature ranges of ICs, using a linear leakage model for each functional unit results in less than 1% error in leakage estimation (Section 7.2).

2) We demonstrate that IC packages and cooling structures have the useful property that a given amount of heat produced within the active layer of an IC will have similar impact on the average temperature of the active layer, regardless of its distribution (Section 7.3).

3) We use the two properties described above to prove that within regions of uniform design style, knowledge of the average temperature is sufficient to accurately determine leakage power consumption. Based on this result, we show that leakage can be predicted using a simple, coarse-grained model without sacrificing accuracy (Section 7.4).

4) We validate the proposed technique via analytical proofs and simulation results. We demonstrate that for a wide range of ICs, a simplified thermal model in which only one thermal element is used for each functional unit permits a speedup in leakage estimation of 59,259×-1,790,000× while maintaining accuracy to within 1% (Section 7.5), when compared with a conventional approach that uses a detailed thermal model.

7.2. Proposed Leakage Model

This section introduces IC leakage power consumption and characterizes leakage modeling linearization.

7.2.A. IC Leakage Sources

IC leakage current consists of various components, such as subthreshold leakage, gate leakage, reverse-biased junction leakage, punch-through leakage, and gate-induced drain leakage. Among these, subthreshold leakage and gate leakage are dominant [31]. They will be the focus of our analysis.

Considering weak inversion Drain-Induced Barrier Lowering and body effect, the subthreshold leakage current of a MOS device can be modeled as follows [42]:

$${I}_{subthreshold} = {A}_{s} \frac{W}{L} {v}_{T}^{2} ( 1 - {ⅇ}^{\frac{- {v}_{DS}}{{v}_{T}}} ) {ⅇ}^{\frac{( {V}_{GS} - {v}_{th} )}{n {v}_{T}}} \qquad ( 48 )$$

where
As is a technology-dependent constant,
Vₜₕ is the threshold voltage,
L and W are the device effective channel length and width,
V_{GS} is the gate-to-source voltage,
n is the subthreshold swing coefficient for the transistor,
V_{DS} is the drain-to-source voltage, and
v_{T} is the thermal voltage.
V_{DS}>>v_{T} and v_{T}=kT/q. Therefore, Equation 48 can be reduced to

$${I}_{subthreshold} = {A}_{s} \frac{W}{L} {( \frac{kT}{q} )}^{2} {ⅇ}^{\frac{q ( {V}_{GS} - {v}_{th} )}{n k T}} \qquad ( 49 )$$

The gate leakage of a MOS device results from tunneling between the gate terminal and the other three terminals (source, drain, and body). Gate leakage can be modeled as follows [43]:

$${I}_{gate} = {{WLA}_{J} ( \frac{{T}_{oxr}}{{T}_{ox}} )}^{n t} \frac{{V}_{g} {V}_{aux}}{{T}_{ox}^{2}} {ⅇ}^{\sim {BT}_{ox} ( a - b \vert {V}_{ox} \vert ) ( 1 + c \vert {V}_{ox} \vert )} \qquad ( 50 )$$

where
A_{J};B, a, b, and c are technology-dependent constants,
nt is a fitting parameter with a default value of one,
Vₒₓ is the voltage across gate dielectric,
Tₒₓ is gate dielectric thickness,
Tₒₓᵣ is the reference oxide thickness,
Vₐᵤₓ is an auxiliary function that approximates the density of tunneling carriers and available states, and
V_{g} is the gate voltage.
   7.2.B. Thermal Dependency Linearizion

Equations 48-50 demonstrate that subthreshold leakage depends primarily on temperature, supply voltage, and body bias voltage. Gate leakage, in contrast, is primarily affected by supply voltage and gate dielectric thickness, but is insensitive to temperature. Using the Taylor series expansion at a reference temperature T_{ref}, the total IC leakage current of a MOS device can be expressed as follows:

$$\begin{matrix}{I}_{leakage} ( T ) = {I}_{subthreshold} + {I}_{gate} \\ = {A}_{s} \frac{W}{L} {( \frac{k}{q} )}^{2} {T}^{2} {ⅇ}^{\frac{q ( {V}_{GS} - {V}_{th} )}{n k T}} + {I}_{gate} \\ = {I}_{linear} ( T ) + {I}_{high\_order} ( T )\end{matrix} \qquad ( 51 \text{-} 53 )$$

where the linear portion Iₗᵢₙₑₐᵣ(T) is

$${I}_{linear} ( T ) = {I}_{gate} + {A}_{s} \frac{W}{L} {( \frac{k}{q} )}^{2} {ⅇ}^{\frac{q ( {V}_{GS} - {V}_{th} )}{n k {T}_{ref}}} \times ( {T}_{ref}^{2} + ( 2 {T}_{ref} - \frac{q ( {V}_{GS} - {V}_{th} )}{n k} ) ( T - {T}_{ref} ) ) \qquad ( 54 )$$

and the high-order portion I_{high}_{_{—}}_{order}(T) is

$${I}_{high\_order} ( T ) = {I}_{leakage}^{″} ( {T}_{ref} ) {( T - {T}_{ref} )}^{2} + O ( {( T - {T}_{ref} )}^{3} ) \qquad ( 55 )$$

Therefore, the estimation error resulting from truncation of superlinear terms is bounded as follows:

$$Err = \vert \frac{{I}_{high\_order} ( T )}{{I}_{leakage} ( T )} \vert \qquad ( 56 )$$

Equations 55 and 56 demonstrate that the estimation error of the linear leakage power model is a function of |T−T_{ref}|, i.e., the difference between the actual circuit temperature T and the reference temperature T_{ref} at which the linear model is derived. Therefore, to minimize the estimation error, the linear leakage model should be derived as close as possible to the actual subcircuit temperature. This can be intuitively understood from FIG. 15, which shows the normalized leakage power consumption of two circuits (a combinational circuit benchmark c7552 [44] and SRAM [45]) as a function of temperature. For each circuit, we can compare linear and three-segment piecewise linear (PWL 3) models with HSPICE simulation results for the 65 nm predictive technology model [46]. Within the normal operating temperature ranges of many ICs, 55° C.-85° C., even a linear model is fairly accurate. This accuracy can be further improved by using a piece-wise linear model. Accuracy improves with segment count although, in practice, only a few segments are needed. If a continuous leakage function is available, e.g., via curve fitting to measured or simulated results, the first and second terms of its Taylor series expansion at the average temperature of the IC or subcircuit of interest can be used to provide a derivative-based linear model at the reference temperature of interest.

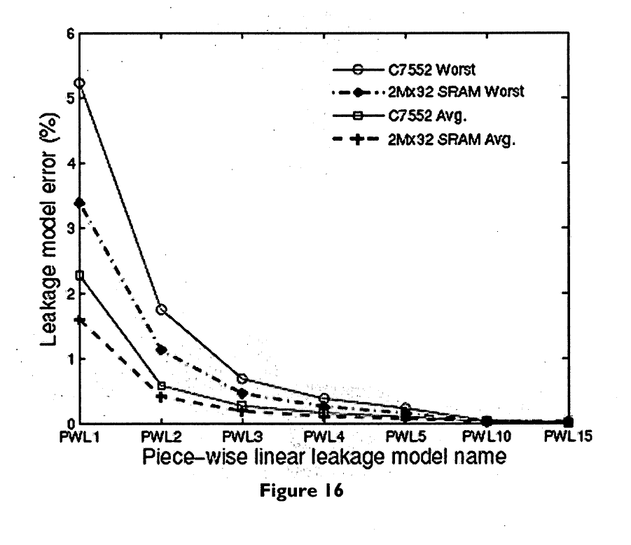

FIG. 16 shows average and maximum leakage model error as functions of piece-wise linear model segment count for the same two circuits considered in FIG. 15. Comparisons with HSPICE simulation are used to compute error. Leakage was modeled in the IC temperature range of 25° C.-120° C. Within each piece-wise linear region, a linear leakage model is derived at the average temperature of this region using Equation 54. The accuracy permitted by the piecewise linear model is determined by the granularity of the regions. FIG. 16 shows that modeling error decreases as the number of linear segments increases. For three or more segments, the maximum errors are less than 0.69% and 0.47% for c7552 and SRAM, respectively. These results demonstrate that coarse-grained piece-wise linear models permit good leakage estimation accuracy. Finer granularity or differentiation of curve fitted continuous functions will generally further improve accuracy, at the cost of increased complexity.

7.3. Thermal Model and Properties

This section introduces the thermal model typically used in detailed temperature-aware IC leakage estimation and explains the properties of IC cooling solutions that permit use of the proposed leakage analysis technique.

7.3.A. Thermal Model Introduction

To conduct numerical thermal analysis, the IC chip and package are partitioned into numerous elements. This permits heat flow to be modeled in the same manner as electrical current in a distributed RC network [47], [48].

$$C \frac{ⅆ \vec{T} ( t )}{ⅆ t} = A \vec{T} ( t ) - \vec{p} U ( t ) \qquad ( 57 )$$

where

C is an n×n diagonal thermal capacitance matrix,

A is an n×n thermal conductance matrix,

\vec{T}(t)=[T₁−T_{A}; T₂−T_{A}; . . . ; Tₙ−T_{A}]^{T} is the temperature vector in which T_{A} is the ambient temperature,

\vec{p}=[p₁; p₂; . . . ; pₙ]^{T} is the power vector, and

U(t) is a step function.

In steady-state thermal analysis, the thermal profile does not vary with time. Therefore, we can denote lim_{t→inf}\vec{T}(t) as \vec{T}, allowing Equation 57 to be simplified as follows:

$$\vec{p} = A \times \vec{T} = [ \begin{matrix}{a}_{11} & {a}_{12} & ⋯ & {a}_{1 n} \\ {a}_{21} & {a}_{22} & ⋯ & {a}_{2 n} \\ ⋮ & ⋮ & ⋰ & ⋮ \\ {a}_{n 1} & {a}_{n 2} & ⋯ & {a}_{n n}\end{matrix} ] \times \vec{T}$$

The thermal resistance matrix R is the inversion of thermal conductance matrix, i.e., R=A⁻¹.
7.3.B. Insensitivity to Power Profile Claim and Proof

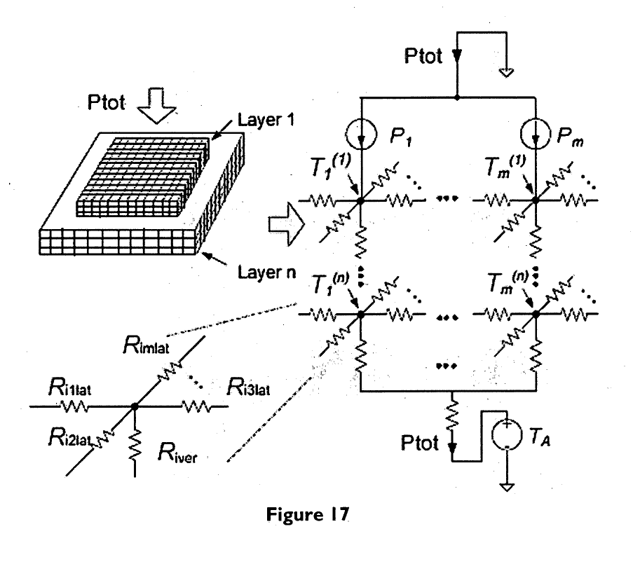

A typical IC thermal model is shown in FIG. 17. In order to accurately model spatial temperature variation, several layers of thermal elements are generally necessary between the active layer and heat sink to permit accurate thermal analysis. Assuming an IC floorplan within which the active layer is divided into m isothermal blocks, blkᵢ, i∈1, 2, . . . , m, the temperature, area, and power consumption of blkᵢ are expressed as Tᵢ, sᵢ, and pᵢ. The total power consumption of the chip is Pₜₒₜ=Σᵢ₌₁^{m}pᵢ. The matrix, S, holds the values of vector \vec{s}, [s₁, s₂, . . . , sₘ, . . . , sₙ] along its diagonal. We now prove that a useful property of IC cooling solutions permits use of the proposed leakage estimation technique.

Theorem 1 (Sum of Products Area-Temperature Conservation): For all IC cooling configurations, as long as the total power input is constant, the sum of the IC area-temperature product in the active layer, Σᵢ₌₁^{m}sᵢTᵢ, is constant if and only if each power source has the same impact on the average temperature of the active layer. That is, the sub-block of area-weighted thermal resistance matrix S×R associated with the active layer should have the equal column sum property. The theorem can also be expressed as follows:

$$\begin{matrix}{\sum }_{i = 1}^{m} {s}_{i} {T}_{i} ∼ {P}_{tot} & ⟺ & ∀ {R}_{j} , {R}_{j} = {R}_{const}\end{matrix} \qquad ( 58 )$$

where Rⱼ=Σᵢ₌₁^{m}sᵢRᵢⱼ, Rᵢⱼ is the i^{th} row and j^{th} column item of the thermal resistance matrix R, and R_{const} is a constant decided by the material and thickness of the chip.

Proof: Assuming the following condition holds,
∀Rⱼ:Rⱼ=R_{const} (59)
the sufficiency of the theorem can be proven.

$${\sum }_{i = 1}^{m} {s}_{i} {T}_{i} = {\sum }_{j = 1}^{m} {\sum }_{i = 1}^{m} {s}_{i} {R}_{ij} {p}_{j} = {\sum }_{j = 1}^{m} {R}_{j} {p}_{j} \qquad ( 60 )$$

According to Condition 12, Equation 60 can be rewritten as:

$${\sum }_{i = 1}^{m} {s}_{i} {T}_{i} = {R}_{const} {P}_{tot} \qquad ( 61 )$$

Therefore, if Condition 12 holds, the sum of each block's area-temperature product Σᵢ₌₁^{m}sᵢTᵢ in the active layer keeps constant, as long as the total power input is constant. In particular the sum of area-temperature products, Σᵢ₌₁^{m}sᵢTᵢ=SₜₒₜT_{avg}, i.e., the area-average temperature product of the IC, remains constant.

Next, we prove the necessity of the theorem. If Condition 12 does not hold, the sum of each block's area-temperature product Σᵢ₌₁^{m}sᵢTᵢ in the active layer does not remain constant with changing power profile, even if total power consumption is constant. Assume, without loss of generality, there are regions with high and low thermal impact on the active layer: R_{high}=Σᵢ₌₁^{m}sᵢRᵢⱼ, j∈1, 2, . . . , q, and R_{low}=Σᵢ₌₁^{m}sᵢRᵢⱼ, j∈q+1, . . . , m. The total power can be divided into two parts accordingly, Pₜₒₜ=P_{high}+P_{low}. Thus, the sum of area-temperature product can be expressed as follows:

$${\sum }_{i = 1}^{m} {s}_{i} {T}_{i} = {\sum }_{j = 1}^{q} {R}_{high} {p}_{j} + {\sum }_{j = q + 1}^{m} {R}_{low} {p}_{j} = {R}_{high} {P}_{high} + {R}_{low} {P}_{low} \qquad ( 62 )$$

Even if Pₜₒₜ is constant, it is clear that a differing ratio between P_{high} and P_{low} makes the sum of area-temperature products different. Necessity is proved.

We will show that for a typical multiple layer IC and cooling configuration, the sufficient and necessary conditions for the Theorem 1 are satisfied, based on the following assumptions:

1) All heat generated in the active layer flows eventually to the ambient through the top of the heatsink or the bottom of the package, i.e., no heat flows the sides of the silicon; and

2) All layers either have the same area or are isothermal.
We will later demonstrate that these assumptions are well satisfied for a wide range of ICs. Due to space constraints, we can only summarize the proof that these assumptions permit the use of Theorem 1. However, this summary illustrates the reasons for the high accuracy indicated by the results in Section 7.5. We first generate a thermal conductance matrix Aⱼ for each layer j. Aⱼ is clearly a real symmetric m×m matrix, in which the sum of items in the i^{th} row (or column) equals

$$\frac{{k}_{con} \cdot {s}_{i}}{{t}_{die}} ,$$

where k_{con} is the silicon thermal conductivity and t_{die} is the thickness of the layer. We transform Aⱼ to Bⱼ by factoring the area of each block si out of matrix Aⱼ using matrix Sⱼ. We prove that matrix Bⱼ has the equal column sum property and that the sum is

$$\frac{{k}_{con}}{{t}_{die}} .$$

For matrix M, with the equal column sum property, it is easy to prove the following properties. Given that ζ is an arbitrary set of matrices and β is the set of all matrices having the equal column sum property,

$$ζ ⊆ β ⇒ ( {\sum }_{M ∈ ζ} M ) ∈ β ⋀ ( {\prod }_{M ∈ ζ} M ) ∈ β \\ {∀}_{M ∈ β} : ∃ {M}^{- 1} ⇒ {M}^{- 1} ∈ β \qquad ( 63 , 64 )$$

For the multiple layer case, we can prove that the sub-block of area-weighted thermal resistance matrix S×R associated with the active layer can be expressed as a linear combination of matrices Bⱼ∈β from each layer j. In this way, we prove that the Condition 12 is satisfied. We will further validate the sufficient and necessary conditions under realistic cooling configurations in Section 7.5.
7.4. Temperature-Aware Leakage Estimation

This section describes the approach conventionally used for temperature-aware leakage estimation and proposes a new accurate and fast technique.

7.4.A. Conventional Approach

In the past, most attempts at temperature-aware leakage power consumption estimation used fine-grained thermal analysis to compute leakage power consumption [40], [41]. It can be surmised that this is due to the superlinear relationship between leakage and temperature. After partitioning the IC into thousands of thermal elements, the leakage current for each thermal element is computed based on the corresponding estimated temperature. The total leakage current is computed by taking the sum of the leakage of all thermal elements. Since the number of thermal elements is large, most computation time is spent estimating the detailed thermal profile in the conventional approach. This prevents efficient leakage estimation for many candidate solutions during synthesis or early design space exploration.

7.4.B. Proposed Method

In this section, we propose a fast and accurate temperature-dependent leakage estimation method. Assume the IC is divided into n isothermal homogeneous grid elements, blkᵢ, i∈1, 2; . . . , n. The temperature, area, and power consumption of each element, blkᵢ, are expressed as Tᵢ, sᵢ, and pᵢ, respectively. Using the linear leakage model developed in Section 7.2, the leakage power of blkᵢ is expressed as follows:
pₗₑₐₖ^{blk}^{ᵢ}(Tᵢ)≅V_{DD}Iₗᵢₙₑₐᵣ^{blk}^{ᵢ}(Tᵢ) (65)
For a subcircuit with uniform design style, the leakage current is proportional to its area, i.e.,
Iₗᵢₙₑₐᵣ^{blk}^{ᵢ}(Tᵢ)∝Fᵢsᵢ (66)
yielding the following formula:
Iₗᵢₙₑₐᵣ^{blk}^{ᵢ}(Tᵢ)=Fᵢsᵢ(MᵢTᵢ+Nᵢ) (67)
where Fᵢ is the leakage current per unit area. This value depends on manufacturing technology, design style, supply voltage and input pattern. Since input vectors have a great influence on the leakage current, the leakage current should be an input vector probability weighted one. Mᵢ and Nᵢ are parameters obtained by curve fitting in the piece-wise linear model. Collectively, Fᵢ, Mᵢ, and Nᵢ are referred to as leakage coefficients. If the derivative model is used, Mᵢ and Nᵢ are calculated at the estimated Tᵢ using the Taylor series expansion technique developed in Section 7.2.

Uniform Case: Fᵢ, Mᵢ, and Nᵢ are decided only by the circuit design style, supply voltage and input pattern. For an IC with uniform design style and supply voltage, such as SRAM and field-programmable gate arrays (FPGAs), these values are the same under specific input patterns for all portions of the IC and can be denoted as F_{tech}, and M and N, respectively. Theorem 1 can be used to show that

$$\begin{matrix}{\sum }_{i = 1}^{n} {I}_{linear}^{{blk}_{i}} ( {T}_{i} ) = {MF}_{tech} {\sum }_{i = 1}^{n} ( {s}_{i} {T}_{i} ) + {F}_{tech} N {\sum }_{i = 1}^{n} ( {s}_{i} ) \\ = {F}_{tech} {S}_{tot} ( {MT}_{avg} + N )\end{matrix} \qquad ( 68 , 69 )$$

Therefore, as long as the conditions necessary to use Theorem 1 are well satisfied, only a few thermal elements are needed for accurate leakage analysis of the entire IC. This permits highly-efficient leakage estimation.

Nonuniform Case: Many ICs are composed of regions with different design styles, e.g., logic and memory, or with different supply voltages. These regions have different Fᵢ, Mᵢ, and Nᵢ values. In this case, we divide the chip into regions, within which the leakage coefficients are consistent. Therefore, the leakage current for region k is expressed as follows:

$$\begin{matrix}{\sum }_{{blk}_{i} ∈ {reg}_{k}} {I}_{linear}^{{blk}_{i}} ( {T}_{i} ) = {M}_{k} {F}_{k} {\sum }_{i = 1}^{n} ( {s}_{i} {T}_{i} ) + {F}_{k} {N}_{k} {\sum }_{i = 1}^{n} ( {s}_{i} ) \\ = {F}_{k} {S}_{tot} ( {M}_{k} {T}_{k}^{reg} + {N}_{k} )\end{matrix} \qquad ( 70 )$$

Where Tₖ^{reg} is the average temperature of region k. By summing the leakage current of all regions, the total leakage current is obtained. The use of only one, or a few, thermal elements for each region allows extremely fast thermal and leakage analysis.

Multiple thermal elements may also be used in cases for which the IC leakage coefficients are uniform in order to increase estimation accuracy. Finer thermal model granularity implies smaller temperature variations within each thermal element. Recall that the estimation accuracy of a linear model depends on deviation between the actual temperature and the reference temperature at which the linear model was derived. Decreasing the size of a thermal element decreases the temperature variation within it. Therefore, decreasing thermal element size decreases the truncation error resulting from using a linear approximation of the superlinear leakage function. Our results in Section 7.5 indicate that, even given pathological power and temperature profiles, very few thermal elements are required for leakage estimation with less than 1% error.

Leakage power consumption influences temperature, which in turn influences leakage power consumption. This feedback can be handled by repeating thermal analysis until convergence. This usually requires only a few iterations for most ICs. More advanced techniques to model this feedback loop may also be devised, but are beyond the scope of this article.

7.5. Experimental Results

In this section, we evaluate the accuracy and efficiency of the proposed temperature-dependent leakage estimation technique, which consists of piece-wise linear leakage modeling and coarse-grained thermal analysis. We characterize the two sources of leakage estimation error introduced by this technique: truncation error as a result of using a linear leakage model and temperature error as a result of using a coarse-grained thermal model. The base case for comparison is conventional temperature-aware leakage estimation using superlinear leakage model and fine-grained thermal analysis. Our experiments demonstrate that for a set of FPGA, SRAM, microprocessor, and application specific integrated circuit (ASIC) benchmarks, the proposed leakage modeling technique is accurate and permits great increases in efficiency. All benchmarks were run on an AMD Athlon-based Linux PC with 1 GB of RAM.

7.5.A. Experimental Setup

We use the 65 nm predictive technology model [46], for leakage modeling. This model characterizes the impact of temperature on device leakage. We first derive the superlinear leakage model using HSPICE simulation. The piece-wise linear leakage model is then derived using the method described in Section 7.2: partitioning the temperature range into uniform segments and using least-squared error fitting for each segment. The derivative-based model is based on the first two terms of the Taylor series expansion of the superlinear leakage function around the reference temperature of interest.

We use HotSpot3.0 [49] for both coarse-grained and fine-grained steady-state thermal analysis. HotSpot3.0 supports both block-based coarse-grained and grid-based fine-grained stead-state thermal analysis. Previous work [50] demonstrated that the coarse-grained block-based method is fast. In contrast, fine-grained grid-based partitioning is slower but permits more accurate thermal analysis. In this work, coarse-grain thermal analysis is based on the block-based method, as only the average block temperature is required. For fine-grained thermal modeling, we partition the IC active layer into 100×100 elements. This resolution is necessary; decreasing resolution to 50×50 resulted in a 6° C. error in peak temperature for the Alpha 21264. A resolution of 100×100 elements is also sufficient for our benchmarks; we have used resolutions up to 1,000×1,000 to validate our results and have found that increasing resolution beyond 100×100 has little impact on temperature estimation accuracy.

7.5.B. Leakage Power Estimation

Table 6 shows the accuracy and speedup resulting from using the proposed leakage estimation technique on an FPGA [51]. We used six sets of 30 random power profiles. Six different total power consumptions (Column 2) resulting in different average temperatures (Column 1) were considered. Power profiles were generated by assigning uniformly-distributed random samples ranging from [0, 1] to each cell in a 5×5 array overlaying the IC and then adjusting the power values to reach the target total IC power while maintaining the ratios of power consumptions among cells.

TABLE 6
Leakage error for FPGA

| | |
|---|---|
| DM error | CPU time |

| T_{avg} | Pₗₒₜ | Avg. | Max. | SF | DM | Speedup |
|---|---|---|---|---|---|---|
| (° C.) | (W) | (%) | (%) | (s) | (μs) | (million x) |
| 40 | 10 | 0.003 | 0.005 | 16.1 | 10 | 1.60 |
| 50 | 40 | 0.039 | 0.092 | 14.7 | 10 | 1.47 |
| 60 | 70 | 0.122 | 0.258 | 16.1 | 10 | 1.61 |
| 70 | 110 | 0.300 | 0.650 | 16.2 | 10 | 1.62 |
| 80 | 150 | 0.505 | 0.960 | 16.2 | 9 | 1.79 |
| 90 | 180 | 0.731 | 1.205 | 16.0 | 9 | 1.78 |

In Section 7.4 we showed that the leakage power of an IC with uniform leakage coefficients depends only on total power consumption. To evaluate this, we compared the superlinear fine-grained model (SF) with the single-element linear derivative-based model (DM). At each total power setting, the average estimation error for the 30 randomized power profiles is shown in Column 3. As shown in Column 4, the maximum estimation error was never greater than 1.2%. As shown in Columns 5-7, the speedup permitted by our technique ranges from 1,470,000×-1,790,000×. This speedup results from a reduction in thermal model complexity that greatly accelerates the thermal analysis portion of leakage estimation.

In addition to considering modeling accuracy for uniform leakage coefficients in the presence of randomized power profiles, we designed a power profile to determine the error of the proposed technique under pathological conditions. In this configuration, all of the power in the IC was consumed by a corner block and other blocks consumed no power. The total power input was set to 117 W, leading to an extremely unbalanced thermal profile. Temperatures ranged from 52.85° C. to 106.85° C. This case goes well beyond what can be expected in practice, but serves to establish a bound on the estimation error of the proposed approach.

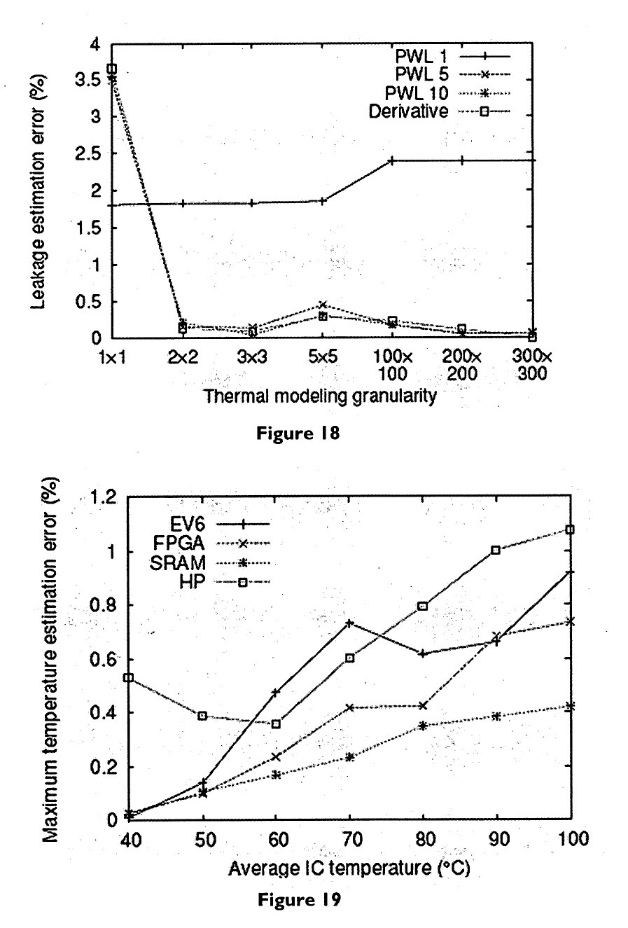

FIG. 18 shows the leakage estimation error as a function of thermal modeling granularity for piece-wise linear thermal models with various numbers of segments and a linear model based on the derivative of the continuous leakage function at the block's predicted temperature. Using the same one-segment linear model for all blocks (PWL 1) results in approximately 2% estimation error. However, piece-wise linear models with five or more segments, and the derivative-based model, all maintain errors of less than 0.5%, as long as at least four thermal elements are used. Note that the derivative based model is not identical to a piece-wise linear model in which the number of segments approaches infinity because the piecewise linear model is fit to the leakage function using a least-squared error minimizer while the derivative based model is based on the Taylor series expansion around a single temperature. Therefore, it is possible for the piece-wise linear model to result in higher accuracy in some cases. From these data, we can conclude that even when faced with extreme power profiles, only a few thermal elements are necessary to permit high leakage power estimation accuracy.

In addition to considering ICs with uniform design styles, e.g., FPGAs, we have evaluated the proposed technique when used on the Alpha 21264 processor, an IC having regions with different sets of leakage coefficients, e.g., control logic, datapath, and memory. Power traces were generated using the Wattch power/performance simulator [52] running SPEC2000 programs. One thermal element is used for each functional unit in the processor. Table 7 shows results for five-segment piece-wise linear (PWL 5) and derivative-based (DM) leakage models. Row 4 shows that reducing thermal model complexity results in leakage estimation speedups ranging from 59,259×-80,965×. As Rows 2 and 3 show, derivative-based and piece-wise linear model leakage estimation errors are less than 1% for all benchmarks, compared with an HSPICE-based superlinear leakage model used with fine-grained thermal analysis. This small error has two components: truncation error resulting from coarse-grained thermal modeling and slight deviation of real cooling structures from the conditions stated in Theorem 1. We now discuss the conditions required by Theorem 1.

TABLE 7
Leakage error for Alpha 21264

| Benchmark | | gcc | equake | mesa | gzip | art | bzip2 | twolf |
|---|---|---|---|---|---|---|---|---|
| Error (%) | PWL 5 | 0.52 | 0.71 | 0.53 | 0.42 | 0.34 | 0.45 | 0.65 |
| | DM | 0.54 | 0.64 | 0.51 | 0.48 | 0.56 | 0.47 | 0.57 |

| | | | | | | | |
|---|---|---|---|---|---|---|---|
| Speedup | 59 | 67 | 65 | 81 | 66 | 67 | 66 |
| (thousand x) | | | | | | | |

7.5. C. Thermal Model Error Breakdown

In Section 7.3, we showed that the necessary and sufficient conditions for Theorem 1 hold under reasonable assumptions. IC cooling structures approximately conform to the assumptions required for sum of products area-temperature conservation to hold, e.g., much more heat leaves an IC and package through the heatsink than through the sides of the silicon die. However, they do not perfectly conform, e.g., some heat can leave the system through the sides of the die. We now evaluate the error resulting from approximating the conditions required to use Theorem 1. We use several ICs with differing floorplans: FPGA, SRAM [53], Alpha 21264, and HP, an ASIC benchmark from MCNC benchmark suite [54], to compare sum of area-temperature products (SATP) values given different power profiles. For each IC, SATP is calculated for 30 randomized power profiles, which are generated in same way as those for Table 6. Each IC has a different area. Therefore, total power consumption values were chosen to produce each of the six reported average temperatures. Table 8 shows maximum and average differences between the SATP values for the random power profiles and the SATP value for a uniform power profile. From these results, we can conclude that the SATP error is less than 0.6% for all four benchmark ICs. We also computed SATP error for the unbalanced worst-case power FPGA profile used in FIG. 18. The worst-case error is smaller than 0.015% for all thermal model granularities. We conclude that the conditions required to use Theorem 1 are well-satisfied for a wide range of ICs.

TABLE 8
Σᵢ₌₁ⁿ sᵢTᵢ with different power profiles

| | FPGA | | SRAM | | EV6 | | HP | |
|---|---|---|---|---|---|---|---|---|
| | SATP Error (%) | | SATP Error (%) | | SATP Error (%) | | SATP Error (%) | |
| T_{avg} (° C.) | Avg. | Max. | Avg. | Max. | Avg. | Max. | Avg. | Max. |
| 40 | 0.0016 | 0.0019 | 0.0013 | 0.0018 | 0.0002 | 0.0003 | 0.0202 | 0.5407 |
| 50 | 0.0057 | 0.0075 | 0.0097 | 0.0131 | 0.0099 | 0.0115 | 0.0085 | 0.1458 |
| 60 | 0.0099 | 0.0113 | 0.0189 | 0.0247 | 0.0180 | 0.0204 | 0.0139 | 0.2116 |
| 70 | 0.0145 | 0.0169 | 0.0280 | 0.0361 | 0.0263 | 0.0302 | 0.0168 | 0.2093 |
| 80 | 0.0178 | 0.0217 | 0.0337 | 0.0472 | 0.0338 | 0.0389 | 0.0177 | 0.1788 |
| 90 | 0.0224 | 0.0282 | 0.0424 | 0.0570 | 0.0421 | 0.0514 | 0.0215 | 0.1913 |

Although we have shown that the properties required to use Theorem 1 are well-approximated for a number of ICs, we have yet to show the implications of this observation upon temperature estimation accuracy. We partition the IC into blocks, each of which corresponds to a region with uniform leakage coefficients, and compare the average block temperatures with those calculated by using a fine-grained thermal model. FIG. 19 shows the maximum temperature estimation error as a function of average IC temperature for the same set of benchmarks shown in Table 8. Error is computed on the Kelvin scale. FIG. 19 shows that the maximum temperature estimation error over all power profiles is less than 11.1%. For the Alpha 21264 processor we also calculated the temperature differences using power traces from SPEC2000 applications. In all cases, the average temperature difference is less than 0.61%. From this, we can conclude that using a coarse-grained thermal model is sufficient for IC leakage power consumption estimation.

### 8. Example

### Thermal Analysis of a Three-Dimensional IC

The three-dimensional (3-D) integrated circuit chip package setup for this example had a total of 7 layers, including silicon layer 1, interface layer, silicon layer 2, interface layer, silicon layer 3, interface layer, and a heatsink layer. The width and length of all the layers was 4.4 mm, while the thickness of the layers was 0.002 mm, 0.01 mm, 0.002 mm, 0.01 mm, 0.4 mm, 2.0 μm, and 0.5 mm, respectively.

For the analysis, a 3-D multiprocessor was modeled with eight on-chip processor cores, including two processor layers (silicon layers 2 and 3) and an on-chip memory layer (silicon layer 1). The power consumption profile was generated by running a set of SPEC2000 microprocessor benchmarks, including applu, bzip2, gcc, gzip, lucas, mcf, mgrid, and parser. These eight benchmarks were randomly placed on the eight processor core during each test.

We compare the time-domain and frequency-domain methods of the invention with a globally-adaptive fourth-order Runge-Kutta (GRK4) method. Table 9 shows the relative error of the ISAC dynamic time-domain method and the moment-matching method compared with the globally-adaptive fourth-order Runge-Kutta method. The peak temperature listed in Table 9 is the highest temperature (° C.) of all the thermal elements inside the chip package relative to the ambient temperature. The error was calculated by averaging the relative error of all the elements inside the chip package.

TABLE 9
Results of 3-D thermal analysis

| | GRK4 | ISAC | | Moment | |
|---|---|---|---|---|---|
| | peak | time-domain method | | matching method | |
| Benchmark | temp. | Peak temp. | | Peak temp. | Error |
| set | (° C.) | (° C.) | Error (%) | (° C.) | (%) |
| 1 | 81.7265 | 81.7265 | 0.0002 | 81.7309 | 0.005 |
| 2 | 79.6339 | 79.6339 | 0.0002 | 79.6384 | 0.005 |
| 3 | 80.3948 | 80.3948 | 0.0002 | 80.3887 | 0.005 |
| 4 | 81.6951 | 81.6952 | 0.0002 | 81.6995 | 0.005 |
| 5 | 83.1249 | 83.1248 | 0.0002 | 83.1274 | 0.004 |
| 6 | 84.2268 | 84.2268 | 0.0002 | 84.2301 | 0.004 |
| 7 | 80.2459 | 80.2458 | 0.0002 | 80.2486 | 0.004 |
| 8 | 81.8021 | 81.8021 | 0.0002 | 81.7949 | 0.008 |

From Table 9 it can be seen that the simulation results of the time-domain method and the moment-matching frequency-domain method are similar to the results of the globally-adaptive fourth-order Runge-Kutta method, with the highest error being only 0.008%.

All cited publications are incorporated herein by reference in their entirety.

### 9. Equivalents

Those of ordinary skill in the art will recognize, or be able to ascertain through routine experimentation, equivalents to the embodiments described herein. Such embodiments are within the scope of the invention and are covered by the appended claims.

### REFERENCES

[1] International Technology Roadmap for Semiconductors, http://public.itrs.net.
[2] “FLOMERICS,” http://www.flomerics.com.
[3] “ANSYS,” http://www.ansys.com.
[4] “COMSOL Multiphysics,” http://www.comsol.com/products/multiphysics.
[5] K. Skadron, et al., “Temperature-aware microarchitecture,” in Proc. Int. Symp. Computer Architecture, June 2003, pp. 2-13.
[6] P. Li, et al., “Efficient full-chip thermal modeling and analysis,” in Proc. Int. Conf. Computer-Aided Design, November 2004, pp. 319-326.
[7] T. Smy, D. Walkey, and S. Dew, “Transient 3D heat flow analysis for integrated circuit devices using the transmission line matrix method on a quad tree mesh,”Solid-State Electronics, vol. 45, no. 7, pp. 1137-1148, July 2001.
[8] Y. Zhan and S. S. Sapatnekar, “A high efficiency full-chip thermal simulation algorithm,” in Proc. Int. Conf. Computer-Aided Design, October 2005.
[9] P. Liu, et al., “Fast thermal simulation for architecture level dynamic thermal management,” in Proc. Int. Conf. Computer-Aided Design, October 2005.
[10] T.-Y. Chiang, K. Banerjee, and K. C. Saraswat, “Analytical thermal model for multilevel VLSI interconnects incorporating via effect,” IEEE Electron Device Letters, vol. 23, no. 1, pp. 31-33, January 2002.
[11] D. Chen, et al., “Interconnect thermal modeling for accurate simulation of circuit timing and relability,” IEEE Trans. Computer-Aided Design of Integrated Circuits and Systems, vol. 19, no. 2, pp. 197-205, February 2000.
[12] Z. Lu, et al., “Interconnect lifetime prediction under dynamic stress for reliability-aware design,” in Proc. Int. Conf. Computer-Aided Design, November 2004, pp. 327-334.
[13] “Incremental self-adaptive chip-package thermal analysis software,” ISAC link at http://www.ece.queensu.ca/hpages/faculty/shang/projects.html and http://www.ece.northwestern.edu/dickrp/projects.html.
[14] Z. P. Gu, et al., “TAPHS: Thermal-aware unified physical-level and high-level synthesis,” in Proc. Asia & South Pacific Design Automation Conf., January 2006.
[15] P. Wesseling, An Introduction to Multigrid Methods. John Wiley & Sons, 1992.
[16] D. Braess, Finite Elements: Theory, Fast Solvers, and Applications in Solid Mechanics. Cambridge University Press, 2001.
[17] S. S. Rao, Applied Numerical Methods for Engineers and Scientists. Prentice-Hall, Englewood Cliffs, N.J., 2002.
[18] W. H. Press, B. P. F. S. A. Teukolsky, and W. T. Vetterling, Numerical Recipes in FORTRAN: The Art of Scientific Computing. Cambridge University Press, 1992.
[19] V. S. Kozyakin, “Asynchronous systems: A short survey and problems,” Institute for Information Transmission Problems: Russian Academy of Sciences, Tech. Rep., 2000.
[20] J. M. Esposito and V. Kumar, “An asynchronous integration and event detection algorithm for simulating multi-agent hybrid systems,” ACM Trans. Modeling and Computer Simulation, vol. 14, pp. 363-388, October 2004.
[21] A. Devgan and R. A. Rohrer, “Adaptive controlled explicit simulation,” IEEE Trans. Computer-Aided Design of Integrated Circuits and Systems, vol. 13, no. 6, pp. 746-762, June 1994.
[22] Z. Yu, et al., “Full chip thermal simulation,” in Proc. Int. Symp. Quality of Electronic Design, March 2000, pp. 145-149.
[23] J. Cong and M. Sarrafzadeh, “Incremental physical design,” in Proc. Int. Symp. Physical Design, April 2000.
[24] W. Choi and K. Bazargan, “Incremental placement for timing optimization,” in Proc. Int. Conf. Computer-Aided Design, November 2003.
[25] J. S. Kim, et al., “Energy characterization of a tiled architecture processor with on-chip networks,” in Proc. Int. Symp. Low Power Electronics & Design, August 2003, pp. 424-427.
[26] A. Raghunathan, N. K. Jha, and S. Dey, High-level Power Analysis and Optimization. Kluwer Academic Publishers, Boston, 1997.
[27] G. S. Ohm, “The galvanic circuit investigated mathematically,” 1827.
[28] “AMD core math library (ACML),” http://developer.amd.com/acml.aspx.
[29] C. C. Douglas, et al., “GEMMW: A portable level 3 BLAS Winograd variant of Strassen's matrix-matrix multiply algorithm,” J. Computational Physics, vol. 110, pp. 1-10, 1994.
[30] S. T. Pu Liu, et al., “An efficient method for terminal reduction of interconnect circuits considering delay variations,” in Proc. Int. Conf. Computer-Aided Design, October 2005.
[31] “International Technology Roadmap for Semiconductors,” 2005, http://public.itrs.net.
[32] S. Naffziger, et al., “The implementation of a 2-core, multi-threaded itanium family processor,” J. Solid-State Circuits, vol. 41, no. 1, pp. 197-209, January 2006.
[33] J. A. Butts and G. S. Sohi, “A static power model for architects,” in Proc. Int. Symp. Microarchitecture, December 2000, pp. 191-201.
[34] S. M. Martin, et al., “Combined dynamic voltage scaling and adaptive body biasing for lower power microprocessors under dynamic workloads,” in Proc. Int. Conf. Computer-Aided Design, November 2002, pp. 721-725.
[35] S. Narendra, et al., “Full-chip subthreshold leakage power prediction and reduction techniques for sub-0.18 CMOS,” J. Solid-State Circuits, vol. 39, no. 2, pp. 501-510, February 2004.
[36] Y. F. Tsai, et al., “Characterization and modeling of run-time techniques for leakage power reduction,” IEEE Trans. VLSI Systems, vol. 12, no. 11, pp. 1221-1232, November 2004.
[37] A. Abdollahi, F. Fallah, and M. Pedram, “Leakage current reduction in CMOS VLSI circuits by input vector control,” IEEE Trans. VLSI Systems, vol. 12, no. 2, pp. 140-154, February 2004.
[38] K. Roy, S. Mukhopadhyay, and H. Mahmoodi-Meimand, “Leakage current mechanisms and leakage reduction techniques in deepsubmicrometer CMOS circuits,” Proc. IEEE, vol. 91, no. 2, pp. 305-327, February 2003.
[39] Y. Zhang, et al., “HotLeakage: A temperature-aware model of subthreshold and gate leakage for architects,” Univ. of Virginia, Tech. Rep., May 2003, CS-2003-05.
[40] H. Su, et al., “Full chip leakage estimation considering power supply and temperature variations,” in Proc. Int. Symp. Low Power Electronics & Design, August 2003, pp. 78-83.
[41] W. P. Liao, L. He, and K. M. Lepak, “Temperature and supply voltage aware performance and power modeling at microarchitecture level,” IEEE Trans. Computer-Aided Design of Integrated Circuits and Systems, vol. 24, no. 7, pp. 1042-1053, July 2005.
[42] A. Chandrakasan, W. Bowhill, and F. Fox, Design of High-Performance Microprocessor Circuits. IEEE Press, 2001.
[43] K. M. Cao, et al., “BSIM4 gate leakage model including source-drain partition,” in IEDM Technology Dig., December 2000, pp. 815-818.
[44] “ISCAS85 benchmarks suite,” http://www.visc.vt.edu/_mhsiao/iscas85. html.
[45] F. Zhang, “System-level leakage power modeling methodology,” Dept. of Electronics Engg., Tsinghua University,” Bachelor's Degree Thesis, July 2006.
[46] W. Zhao and Y. Cao, “New generation of predictive technology model for sub-45 nm design exploration,” in Proc. Int. Symp. Quality of Electronic Design, March 2006, pp. 585-590.
[47] G. S. Ohm, “The Galvanic circuit investigated mathematically,” 1827.
[48] J. Fourier, The Analytical Theory of Heat, 1822.
[49] K. Skadron, et al., “Temperature-aware microarchitecture,” in Proc. Int. Symp. Computer Architecture, June 2003, pp. 2-13.
[50] W. Huang, et al., “HotSpot: A compact thermal modeling methodology for early-stage VLSI design,” IEEE Trans. VLSI Systems, vol. 14, no. 5, pp. 501-524, May 2006.
[51] I. C. Kuon, “Automated FPGA design verification and layout,” Ph.D. dissertation, Dept. of Electrical and Computer Engg., University of Toronto, July 2004.
[52] D. Brooks, V. Tiwari, and M. Martonosi, “Wattch: A framework for architectural-level power analysis and optimizations,” in Proc. Int. Symp. Computer Architecture, June 2000, pp. 83-94.
[53] “SRAM layout,” SRAM link http://www.eecs.umich.edu/UMichMP/Presentations.
[54] “MCNC benchmarks suite,” http://www.cse.ucsc.edu/research/surf/GSRC/MCNCbench.html.

1. A method of analyzing one or more properties of a system, the one or more properties being described by a plurality of elements, the method comprising at least one of:
(a) subjecting the elements to a recursive refinement multigrid relaxation method incorporating a hybrid tree structure;
(b) adapting temporal and spatial partitioning resolution of the elements; and
(c) adapting spatial partitioning resolution of the elements and modifying frequency domain characteristics of the elements.

2. The method of claim 1, wherein the property of the system is a static property, and the method comprises subjecting the elements to a recursive refinement multigrid relaxation method incorporating a hybrid tree structure.

3. The method of claim 1, wherein the property of the system is a short time scale property, and the method comprises adapting temporal and spatial partitioning resolution of the elements.

4. The method of claim 3, wherein adapting temporal and spatial partitioning resolution of the elements comprises spatially and asynchronously temporally adaptive time marching.

5. The method of claim 1, wherein the property of the system is a long time scale property, and the method comprises adapting spatial partitioning resolution of the elements and modifying frequency domain characteristics of the elements.

6. The method of claim 5, wherein modifying the frequency domain characteristics of the elements comprises using a moment matching algorithm.

7. The method of claim 1, wherein properties of the system include static and short time scale properties, and the method comprises:
subjecting the elements to a recursive refinement multigrid relaxation method incorporating a hybrid tree structure; and
adapting temporal and spatial partitioning resolution of the elements.

8. The method of claim 1, wherein the properties of the system include static, short time scale, and long time scale properties, and the method comprises:
subjecting the elements to a recursive refinement multigrid relaxation method incorporating a hybrid tree structure; and
adapting spatial partitioning resolution of the elements and modifying frequency domain characteristics of the elements.

9. The method of claim 1, wherein the property is temperature.

10. The method of claim 9, wherein the system is an electronic device.

11. The method of claim 10, wherein the electronic device is an integrated circuit.

12. The method of claim 1, wherein the system is three-dimensional.

13. The method of claim 12, wherein the system is an electronic device.

14. The method of claim 13, wherein the electronic device is an integrated circuit.

15. The method of claim 12, wherein the property is temperature.

16. The method of claim 1, adapted for thermal analysis during one or more of design, simulation, synthesis, fabrication, and packaging of an electronic device.

17. A method of producing an electronic device, comprising conducting thermal analysis using a method according to claim 1 on the device during design, simulation, synthesis, fabrication, and/or packaging of the device.

18. The method of claim 17, wherein the electronic device is three-dimensional.

19. An electronic device produced in accordance with the method of claim 1.

20. A tool for thermal analysis during one or more of design, simulation, synthesis, fabrication, and packaging of an electronic device, comprising the method of claim 1, embodied in a computer-readable medium.

21. The tool of claim 20, wherein the electronic device is three-dimensional.
